(19) United States
(12) Patent Application Publication
(10) Pub. No.: US 2026/0071724 A1
(43) Pub. Date: Mar. 12, 2026

(54) MOUNTING ASSEMBLY FOR WALL PANEL ASSEMBLY

(71) Applicant: 2840629 Ontario Inc., Woodbridge (CA)

(72) Inventors: Giuseppe PRIZZI, Kleinburg (CA); Marcello VENAFRO, Toronto (CA); David KOZMA, Woodbridge (CA)

(21) Appl. No.: 19/389,635

(22) Filed: Nov. 14, 2025

Related U.S. Application Data
(63) Continuation of application No. PCT/CA2024/050653, filed on May 15, 2024.
(60) Provisional application No. 63/502,304, filed on May 15, 2023.
(60) Provisional application No. 63/519,816, filed on Aug. 15, 2023.

(51) Int. Cl. F16M 13/02

(52) U.S. Cl. CPC F16M 13/022

(57) ABSTRACT

An accessory mount for securing an accessory to a slatwall includes a base, a stem protruding rearward from the base, and a retainer protruding orthogonally from the stem. The retainer and stem have widths sufficiently narrow for insertion of the retainer and stem into a channel opening in the slatwall when the retainer is oriented parallel to the channel to place the accessory mount in a partially installed position. The accessory mount is rotatable to a fully installed position in which the retainer is oriented perpendicular to the channel and at least a lower portion of a flange of the slatwall extending upward form the opening lower edge is received in a retainer gap between the base and the retainer. The base width is greater than the channel opening, and engages the slatwall adjacent the opening when in and moved between the partially and the fully installed positions.

### CROSS-REFERENCE TO RELATED APPLICATIONS

This application is a continuation of International Application No. PCT/CA2024/050653 filed May 15, 2024, which claims the benefit of U.S. Provisional Patent Application No. 63/519,816, filed Aug. 15, 2023, and U.S. Provisional Patent Application No. 63/502,304, filed May 15, 2023, the entirety of each of which is incorporated herein by reference.

### FIELD

The present disclosure relates generally to slatwall accessories mountable to a slatwall (or similar), and more particularly, to an accessory mount for securing a slatwall accessory to a channel of a slatwall and inhibiting unintended release thereof.

### BACKGROUND

U.S. Pat. No. 6,971,614 (Fischer) purports to disclose a removable clip that stabilizes a hanger mounted on a slatwall assembly formed by a number of horizontally aligned and uniformly spaced slats or boards. The upper and lower end of each slat has a lip with an inside surface, so that adjacent slats form a slot with a narrow outer portion and a wider inner portion. The hanger has an upper end that is inserted into an upper slot, and a lower end that hangs down near a lower adjacent slot. The stabilizing clip has a main body and an extending brace. The body is shaped to firmly snap fit into the lower slot. The brace extends upwardly along a middle slat to form a slot for receiving the lower end of the hanger and retaining it against the surface of the middle slat. In a second embodiment, the clip also includes a riser for supporting the lower end of the hanger and positioning the hanger so that its upper end more fully engages the inside surface of the lip of an upper slat.

U.S. Pat. No. 7,753,217 (Lawson) purports to disclose a retainer shaped and sized to accommodate within it a bracket of a hanger in order to prevent an upward, vertical translation of the bracket, followed by its pivoting and finally fall to the ground, by using one end of the retainer for positioning and stabilizing, with respect to one channel of a slatwall track, one extremity of the bracket, while another end of the retainer, vertically spaced from the aforementioned one, is inserted by snapping into another parallel channel of the slatwall track.

U.S. Pat. No. 11,089,885 (Keller) purports to disclose hooks, fixtures, assemblies, brackets, shelves, attachment points, supports, and similar apparatus for attachment to a display panel. Some disclosed attachments include a baseplate having a rotational axis around which the baseplate is rotated during installation. The baseplate defines at least one clearance providing clearance between the baseplate perimeter edge and a display panel when the baseplate is rotated into position. The baseplate may also include at least one engagement portion limiting the baseplate from being further rotated around the baseplate axis in the installation direction, upon engagement with the display

### SUMMARY

According to some aspects of the teaching disclosed herein, an accessory mount for securing a slatwall accessory to a slatwall includes: a base having a base width and a base back surface including an engagement portion for engaging a front face of the slatwall adjacent a channel opening in the slatwall, and the base defining a connection portion forward of the back surface for connection with an accessory load supporter; a stem protruding rearward from the back surface of the base along a stem axis, the stem fixed relative to the base, and the stem having a stem width perpendicular to the stem axis and parallel to the base width; and a retainer protruding orthogonally from the stem along a retainer axis, the retainer fixed relative to the stem, the retainer having a retainer width parallel to the stem width and the retainer including a retainer abutment surface directed toward the back surface of the base, the retainer abutment surface spaced apart from the back surface by a retainer gap. The retainer width and the stem width are sufficiently narrow for insertion of the retainer and stem between an opening upper edge and an opening lower edge of the channel opening when the retainer axis is oriented parallel to the channel to place the accessory mount in a partially installed position in which the retainer axis is parallel to the channel and the back surface engages the front face of the slatwall adjacent the channel opening. The accessory mount is rotatable to a fully installed position in which the retainer axis is oriented perpendicular to the channel and at least a lower portion of a flange of the slatwall extending upward form the opening lower edge is received in the retainer gap. The base width is greater than the retainer width and the stem width, for providing non-insertability of the base into the channel opening and for providing engagement of the base back surface against the front face of the slatwall when the accessory mount is in and moved between the partially installed position and the fully installed position.

In some examples, the stem includes a planar lower abutment surface for flush engagement with a lower bearing surface of the channel when the accessory mount is in the fully installed position, for inhibiting downward displacement of the accessory mount relative to the slatwall.

In some examples, the lower abutment surface includes a lower rotation-limiting surface for preventing further rotation of the accessory mount in a direction away from the partially installed position when the accessory mount is in the fully installed position, the lower rotation limiting surface disposed at a greater distance from the stem axis than the upper abutment surface.

In some examples, the accessory mount further includes a lower rotation-enabling surface adjacent the lower abutment surface, the lower rotation-enabling surface spaced apart from the stem axis by a distance less than or equal to that of the lower abutment surface.

In some examples, at least one of the stem and the retainer comprises a planar upper abutment surface for flush engagement with an upper bearing surface of the channel when the accessory mount is in the fully installed position, for inhibiting upward displacement of the accessory mount relative to the slatwall. In some examples, the upper abutment surface is disposed on the stem, opposite the lower abutment surface. In some examples, the upper abutment surface is disposed on an end face of the retainer spaced apart from the stem.

In some examples, the upper abutment surface includes an upper rotation-limiting surface for preventing further rotation of the accessory mount in a direction away from the partially installed position when the accessory mount is in the fully installed position, the upper rotation limiting surface disposed at a greater distance from the stem axis than the upper abutment surface.

In some examples, the accessory mount further includes an upper rotation-enabling surface adjacent the upper abutment surface, the upper rotation-enabling surface spaced apart from the stem axis by a distance less than or equal to that of the upper abutment surface.

In some examples, the base, the stem, and the retainer are of integral, unitary construction. In some examples, the accessory mount is formed of a plastic material by injection molding. In some examples, the accessory mount is formed of metal by a casting process. In some examples, the accessory mount is formed by an additive manufacturing process. In some examples, the accessory load supporter is of integral, unitary construction with the base and connected with the connection portion thereof. In some examples, the connection portion of the base comprises a first coupling interface engageable with a second coupling interface of the accessory load supporter for releasably connecting the accessory load supporter and the base.

According to some aspects of the teaching disclosed herein, a combination of a wall panel and an accessory mount for securing a load carrying accessory to the wall panel is disclosed. The wall panel includes: a panel axis extending lengthwise of the wall panel, wherein when the wall panel is mounted to a wall for use, the panel axis is oriented horizontally and parallel to the wall; a panel front face oriented vertically when the wall panel is oriented for use; and a channel extending along a channel axis parallel to the panel axis, the channel including a channel opening in the panel front face, the channel opening defined at least partially by an opening upper edge and an opening lower edge spaced vertically above the opening lower edge when the panel is oriented for use, and the channel including a flange extending upward from the opening upper edge, The accessory mount includes: a base having a base width and a base back surface including an engagement portion for engaging the panel front face adjacent the channel opening, and the base defining a connection portion forward of the back surface for connection with an accessory load supporter; a stem protruding rearward from the back surface of the base along a stem axis, the stem fixed relative to the base, and the stem having a stem width perpendicular to the stem axis and parallel to the base width; and a retainer protruding orthogonally from the stem along a retainer axis, the retainer fixed relative to the stem, the retainer having a retainer width parallel to the stem width and the retainer including a retainer abutment surface directed toward the back surface of the base, the retainer abutment surface spaced apart from the back surface by a retainer gap. The retainer width and the stem width are sufficiently narrow for insertion of the retainer and stem between the opening upper edge and the opening lower edge of the channel opening when the retainer axis is oriented parallel to the channel axis to place the accessory mount in a partially installed position in which the retainer axis is parallel to the channel and the back surface engages the panel front face adjacent the channel opening The accessory mount is rotatable to a fully installed position in which the retainer axis is oriented perpendicular to the channel and at least a lower portion of the flange of the slatwall extending upward form the opening lower edge is received in the retainer gap. The base width is greater than the retainer width and the stem width, for providing non-insertability of the base into the channel opening and for providing engagement of the base back surface against the panel front face when the accessory mount is in and moved between the partially installed position and the fully installed position.

In some examples, the channel is located proximate an upper edge portion of the wall panel when oriented in use, and the front face includes a first front face planar portion extending vertically downward from the opening lower edge, and wherein the base back surface bears against the first front face planar portion.

In some examples, the combination further includes an additional wall panel having a lower edge portion coupled to the upper edge portion, the lower edge portion including a downwardly extending leg overlying the upper edge portion, the leg having a second front face planar portion that extends upwardly from the opening upper edge and is coplanar with the first front face planar portion.

In some examples, the channel includes a lower bearing surface comprising the opening lower edge of the channel and a surface extending inward from the opening lower edge, and wherein the stem comprises a planar lower abutment surface for flush engagement with the lower bearing surface of the channel when the accessory mount is in the fully installed position.

In some examples, the planar lower abutment surface of the stem includes a lower rotation-limiting surface for preventing further rotation of the accessory mount in a direction away from the partially installed position when the accessory mount is in the fully installed position, the lower rotation limiting surface disposed at a greater distance from the stem axis than the upper abutment surface.

According to some aspects, a mounting assembly is configured to be vertically supported by a panel, the panel comprising: a front surface defining a planar surface portion; a recess for receiving the mounting assembly; and a recess-defining surface, for defining the recess, and including: an upper surface portion and a lower surface portion that are co-operatively configured to define an opening of the recess; and a retaining surface portion; the mounting assembly comprising: a retainer; a load supporting configuration, including a load supporter configured to support a load; and an intermediate member, extending between the retainer and the load supporting configuration; wherein: the mounting assembly and the panel are co-operatively configurable for establishing a received configuration, wherein, in the received configuration: the retainer is disposed in the recess; the load supporting configuration and the front surface of the panel are disposed in opposing relationship; and the intermediate member is extending through the opening; the received configuration is configurable for disposition in a release-effective relationship and a retention-effective relationship; while: (i) the received configuration is established, and (ii) the received configuration is disposed in the release-effective relationship: the retainer and the retaining surface portion are co-operatively configured such that the mounting assembly is displaceable, relative to the panel, in a forwardly direction along an axis that is parallel to a normal axis defined by the planar surface portion, by the retaining surface portion; and the intermediate member and the upper and lower surface portions of the recess-defining surface are co-operatively configured such that the mounting assembly is rotatable, relative to the panel, in a release direction, for effectuating the transitioning of the received configuration to the retention-effective relationship; while: (i) the received configuration is established, and (ii) the received configuration is disposed in the retention-effective relationship: the retainer and the retaining surface portion are co-operatively configured such that displacement of the mounting assembly, relative to the panel, in the forwardly direction along an axis that is parallel to the normal axis defined by the planar surface portion, is opposed by the retaining surface portion; the intermediate member and the upper and lower surface portions of the recess-defining surface are co-operatively configured such that: rotation of the mounting assembly, relative to the panel, in the release direction, is opposed; and the mounting assembly is vertically supported by the panel.

Other aspects will be apparent from the description and drawings provided herein.

### BRIEF DESCRIPTION OF DRAWINGS

For a better understanding of the described examples and to show more clearly how they may be carried into effect, reference will now be made, by way of example, to the accompanying drawings in which:

FIG. 1 is a cross-sectional view of an embodiment of a wall panel in accordance with aspects of the teaching disclosed herein;

FIG. 2 is an enlarged view of Detail “A” in FIG. 1;

FIG. 3 is an enlarged view of Detail “B” in FIG. 1;

FIG. 4 is a perspective view of an example slatwall including a plurality of the wall panels of FIG. 1 assembled together and mounted to a wall;

FIG. 5 is an enlarged sectional view of a connection between vertically adjacent ones of the wall panels of FIG. 4;

FIG. 6 is a perspective view of an embodiment of an accessory mount according to aspects of the teaching disclosed herein and a slatwall accessory attached to the accessory mount;

FIG. 7 is another perspective view of the accessory mount and slatwall accessory of FIG. 6;

FIG. 8 is a side view of the accessory mount and slatwall accessory of FIG. 6;

FIG. 9 is an enlarged cross-sectional view of the accessory mount of FIG. 8, along line A-A;

FIG. 10 is a perspective view of the accessory mount and slatwall accessory of FIG. 6 partially installed in a channel of the slatwall of FIG. 4;

FIG. 11 is a perspective view of the accessory mount and slatwall accessory of FIG. 10 fully installed in the slatwall;

FIGS. 12A and 12B are similar to the cross-sectional view of FIG. 9, with FIG. 12A showing the accessory mount in the partially installed position, and FIG. 12B showing the accessory mount in the fully installed position;

FIGS. 12C and 12D are similar to FIGS. 12A and 12B, showing an alternate example of an accessory mount in the partially and fully installed positions, respectively;

FIG. 13 is a perspective view of another example of an accessory mount according to aspects of the teaching disclosed herein and a slatwall accessory attached to the accessory mount;

FIG. 14 is a side view of the accessory mount and slatwall accessory of FIG. 13;

FIG. 15 is a cross-sectional view of the mounting assembly of FIG. 14, along line A-A;

FIG. 16 is a perspective view of the accessory mount and slatwall accessory of FIG. 13 partially installed in a channel of the slatwall of FIG. 4;

FIG. 17 is a perspective view of the accessory mount and slatwall accessory of FIG. 16 fully installed in the slatwall;

FIGS. 18A and 18B are similar to the cross-sectional view of FIG. 15, with FIG. 18A showing the accessory mount in the partially installed position, and FIG. 18B showing the accessory mount in the fully installed position;

FIG. 19 is a perspective view of another example of an accessory mount according to aspects of the teaching disclosed herein and a slatwall accessory attached to the accessory mount;

FIG. 20 is a side view of the accessory mount and slatwall accessory of FIG. 19;

FIG. 21 is a side view of the accessory mount and slatwall accessory of FIG. 20 fully installed in a channel of the wall panel assembly of FIG. 4;

FIG. 22 is a perspective view of another example of an accessory mount according to aspects of the teaching disclosed herein and a slatwall accessory attached to the accessory mount;

FIG. 23 is a perspective view of another example of an accessory mount according to aspects of the teaching disclosed herein and a slatwall accessory attached to the accessory mount;

FIG. 24 is an exploded front perspective view of another example of an accessory mount according to aspects of the teaching disclosed herein and a slatwall accessory attachable to the accessory mount;

FIG. 25 is an exploded rear perspective view of the structure of FIG. 24;

FIG. 26 a rear perspective view of the structure of FIG. 25 showing the slatwall accessory attached to the accessory mount;

FIG. 27 is an exploded front perspective view of another example of an accessory mount according to aspects of the teaching disclosed herein and a slatwall accessory attachable to the accessory mount;

FIG. 28 is an exploded rear perspective view of the structure of FIG. 27;

FIG. 29 a rear perspective view of the structure of FIG. 28 showing the slatwall accessory attached to the accessory mount;

FIG. 30 is a cross-sectional view of another example of a wall panel according to aspects of the teaching disclosed herein;

FIG. 31 is a side view of the accessory mount of FIG. 23 shown fully installed in a channel of the wall panel of FIG. 30;

FIG. 32 is a cross-sectional view of another example of a wall panel according to aspects of the teaching disclosed herein; and

FIG. 33 is a side view of the accessory mount of FIG. 23 shown fully installed in a channel of the wall panel of FIG. 32.

### DETAILED DESCRIPTION

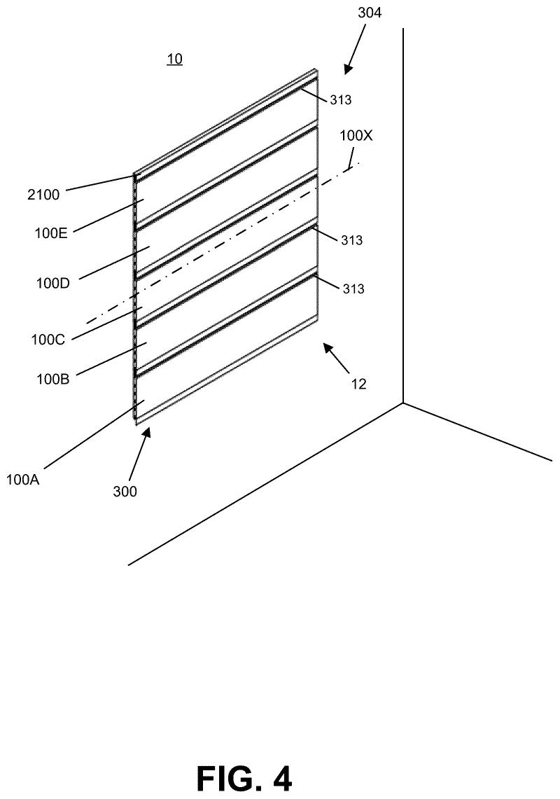

Referring first to FIG. 4, a slatwall 304 is mounted to a wall 10. The slatwall 304 includes at least one horizontal channel 313 for releasably supporting one or more slatwall accessories. In the example illustrated, the slatwall 304 includes multiple channels spaced vertically apart form one another.

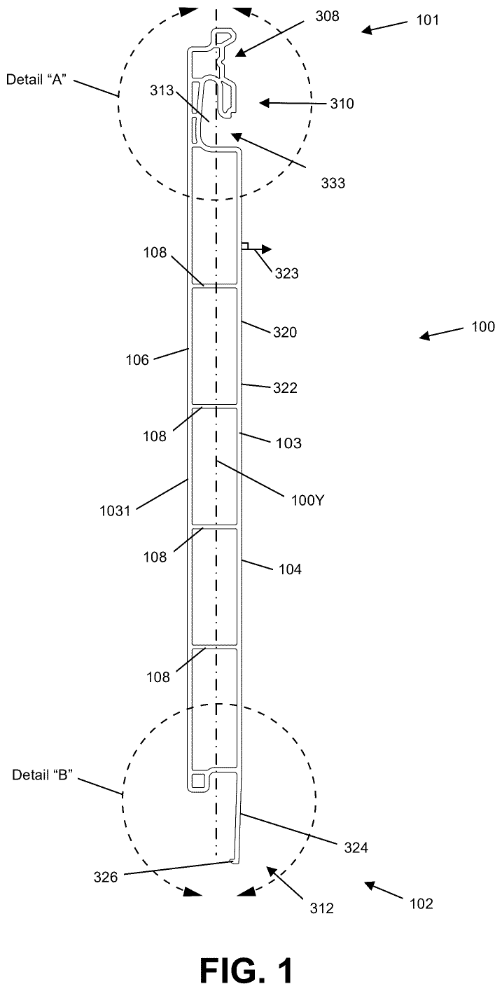

In the example illustrated, the slatwall 304 is formed of a plurality of elongate wall panels (identified at panels 100A-100E, in the example illustrated) that are securable to each other and to the wall 10. The five panels 100A-100E of the slatwall 304 are, in the example illustrated, identical to one another, and share—in the example illustrated—a common extrusion profile as depicted at panel 100 in FIG. 1. In other examples, two or more of the panels 100A-100E may be distinct from one another. The panels 100A-E are oriented horizontally, and secured to the wall 10 in a vertically stacked arrangement.

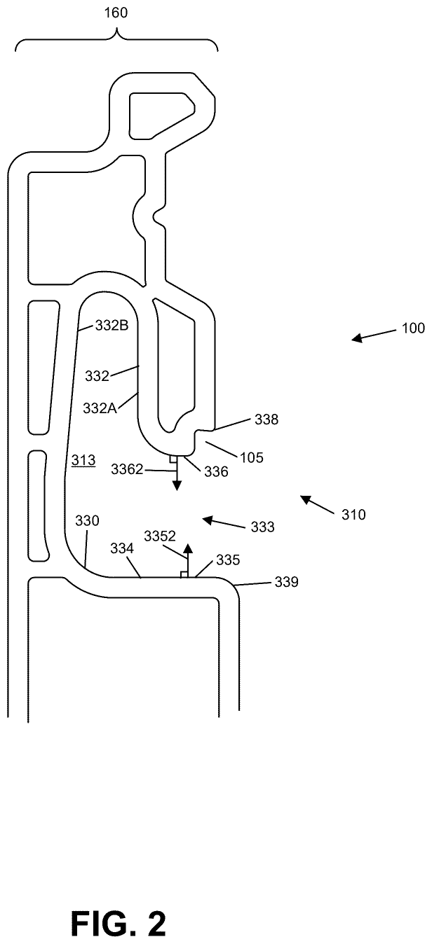

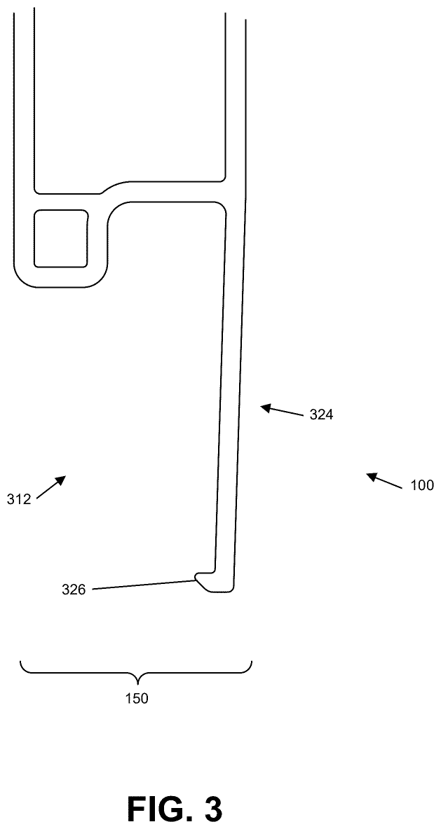

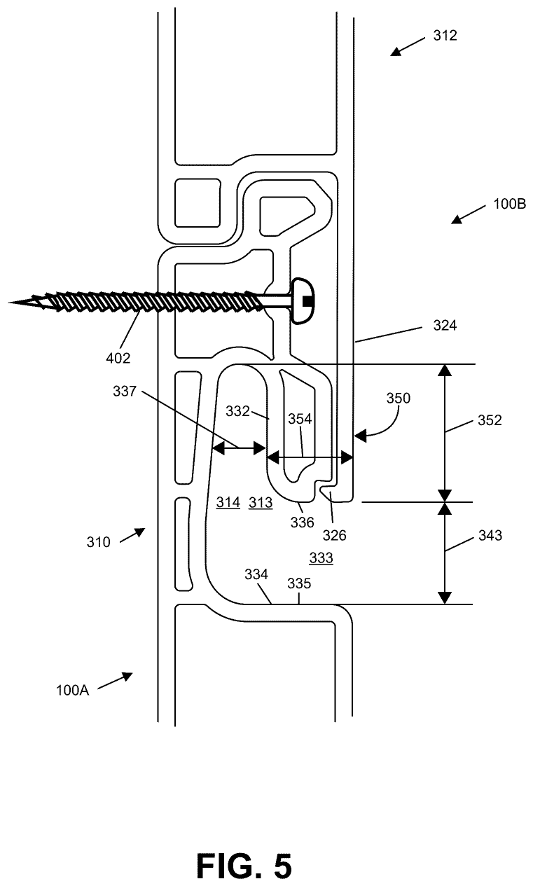

With further reference to FIG. 1, the wall panel 100 has an upper connecting edge portion 310 (shown in greater detail in FIG. 2) and a lower connecting edge portion 312 (shown in greater detail in FIG. 3). A first panel 100 (for example, panel 100A in FIG. 4) is secured to the wall 10 using fasteners 402 which, in the example illustrated, pass through the upper connecting edge portion 310. A second panel 100 (e.g. panel 100B in FIG. 4) is positioned vertically above the first panel 100A so that the lower connecting edge portion 312 of the second panel 100B inter-engages with the upper connecting edge portion 310 of the first panel 100A (see FIG. 5).

In some embodiments, for example, the material of any one of the panels described herein includes plastic, for example, polyvinyl chloride (PVC), polypropylene, or recycled plastic. In some embodiments, for example, the material includes a composite material, such as, for example, wood fibre composite, recycled material, or cellular foam. In some embodiments, for example, the material includes medium-density fibreboard. In some embodiments, for example, the material includes aluminum. In some embodiments, for example, the material includes fibreglass.

In some embodiments, for example, any one of the panels described herein is manufactured by extrusion. In such embodiments, for example, any one of the panels described herein is an extruded lineal. In some embodiments, for example, any one of the panels described herein is manufactured by molding. In some embodiments, for example, any one of the panels described herein is manufactured by pultrusion.

In some embodiments, for example, the first panel 100 defines a cross axis 100Y extending along the height of the panel 100 when oriented as installed on the wall 10. In some embodiments, for example, the cross axis 100Y is perpendicular to a longitudinal axis 100X, oriented lengthwise of the panel in the direction of extrusion of the panel. In some embodiments, for example, the first panel 100 defines a first end 101, a second end 102 that is opposite the first end 101, a front side (first side) 103, and a back side (second side) 1031 opposite the front side 103. In some embodiments, for example, the first and second sides 103, 1031 are connected by ribs 108. A front surface 104 is defined on the first side 103, and a rear surface 106 is defined on the second side 1031. The first panel 100 includes a recess 314 that generally corresponds to a respective channel 313. In some embodiments, for example, the channel 313 is open to the front surface 104 of the panel 100. In some embodiments, for example, the panel 100 defines, at the first end 101, a first coupling configuration counterpart 310, and at the second end 102, a second coupling configuration counterpart 312. In some embodiments, for example, the first panel 100 also includes a fastener receiving portion 308 for one or more of the fasteners 402.

In some embodiments, for example, the respective front surface 104 of a panel 100 defines a visible surface 320 that is visible when the panel is installed for use. In some embodiments, for example, the visible surface 320 includes a respective planar surface 322. In the example illustrated, the planar surface 322 is oriented in a parallel relationship with the wall surface 12 covered by the panels 100.

In some embodiments, for example, the first coupling configuration counterpart 310 of a first panel 100A includes a notch 105, and the second coupling configuration counterpart 312 of a second panel 100B includes a deflectable leg portion 324 with a terminal end defined by a rearwardly extending projection 326. The first coupling configuration counterpart 310 and the second coupling configuration counterpart 312 are co-operatively configured such that when assembled, the rearwardly extending projection 326 is emplaced within the notch 105, with effect that the first and second panels 100A, 100B are coupled together in a snap fit engagement. Simultaneously, while the rearwardly extending projection 326 is being emplaced within the notch 105, a nesting counterpart 160 of the first coupling configuration counterpart 310 of the first panel 100A becomes disposed in a nesting relationship with a nesting counterpart 150 of the second coupling configuration counterpart 312 of the second panel 100B.

Referring again to FIGS. 2 and 5, in the example illustrated, the channel opening 333 is bounded vertically by a channel opening lower surface 335 (also referred to as channel opening lower edge 335) and a channel opening upper surface 336 (also referred to as channel opening upper edge 336). The lower and upper surfaces 335, 336 are spaced vertically apart by an opening gap 343 for receiving an accessory mount therebetween. The channel 313 includes, in the example illustrated, a horizontal channel portion extending into the panel from the channel opening to a vertical wall proximate the back face of the panel. The channel 313 further includes, in the example illustrated, a channel vertical portion extending upward from an inner end portion of the horizontal portion. The channel vertical portion has a depth 337 extending rearward from the retainer abutment surface (inner surface of flange 350) to an inner surface of a rear wall. The channel vertical portion has a height 352 extending from the lower opening surface 336 to an inner surface of a top wall. The height 352 also corresponds to the height or vertical extent of the flange 350 (FIG. 5). The channel vertical portion accommodates a retainer element (e.g. retainer 502) of an accessory mount, as described in more detail subsequently herein.

In the example illustrated, the channel opening lower surface 335 is formed in a first panel 100A. At least a portion of the channel opening upper surface 336 may be formed in the same (first) panel 100A. In the example illustrated, the channel 313 is defined at least in part by a flange 350 extending upward from the channel upper edge 336. In the example illustrated, the flange 350 has a rearwardly directed flange inner surface 332 that faces a forwardly directed channel inner surface. The channel inner surface and the flange inner surface 332 are spaced apart from one another by an upper recess gap 337 (FIG. 5). The channel opening upper surface 336 may comprise an end face of the leg 324 proximate the projection 326 of a second panel 100B (see FIG. 5).

In some examples, The respective recess-defining surface 334 includes a respective upper surface portion 336, extending from the respective upper edge 338 to the respective retaining surface configuration 332 (e.g. to a forwardly-disposed retaining surface portion 332A), and oriented such that a respective axis 3362, that is normal to the respective upper surface portion 336, is disposed, relative to the respective axis 323 that is normal to the respective planar surface portion 322, at an angle that is within a range, wherein the range is from 45 degrees to 135 degrees (such as, for example, from 60 degrees to 120 degrees, such as, for example, from 75 degrees to 105 degrees, such as, for example, 90 degrees). In some embodiments, for example, the upper surface portion 336 includes a planar surface portion 336A.

In some embodiments, for example, the upper surface portion 336 and the lower surface portion 335 are disposed in opposing relationship. In some embodiments, for example, the planar surface portion (of 336) and the planar surface portion (of 335) are parallel.

In some embodiments, for example, there is provided a kit for producing a fastened panel assembly configuration (slatwall) 304, and the kit includes a plurality of panels 100, and each one of the panels, independently, includes the features, described herein, for the panel 100

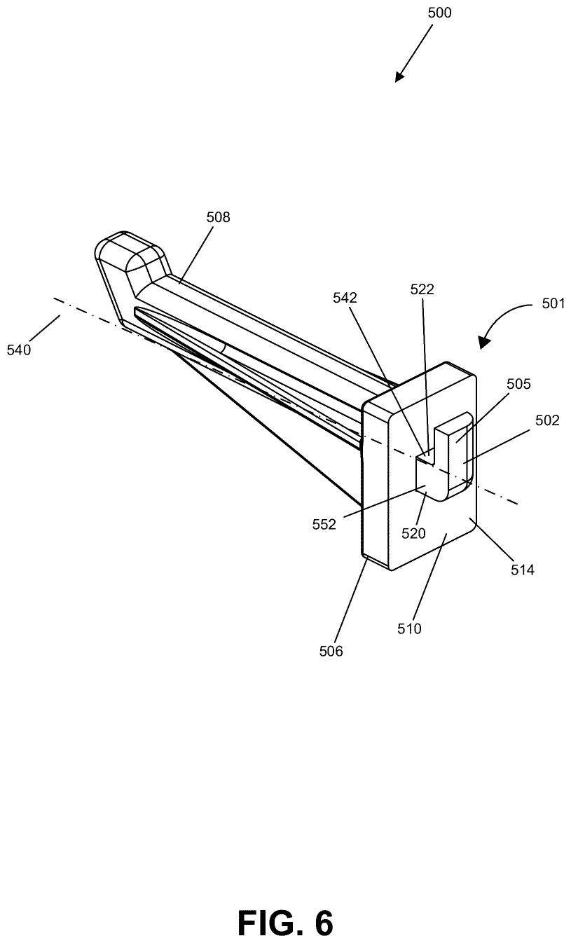

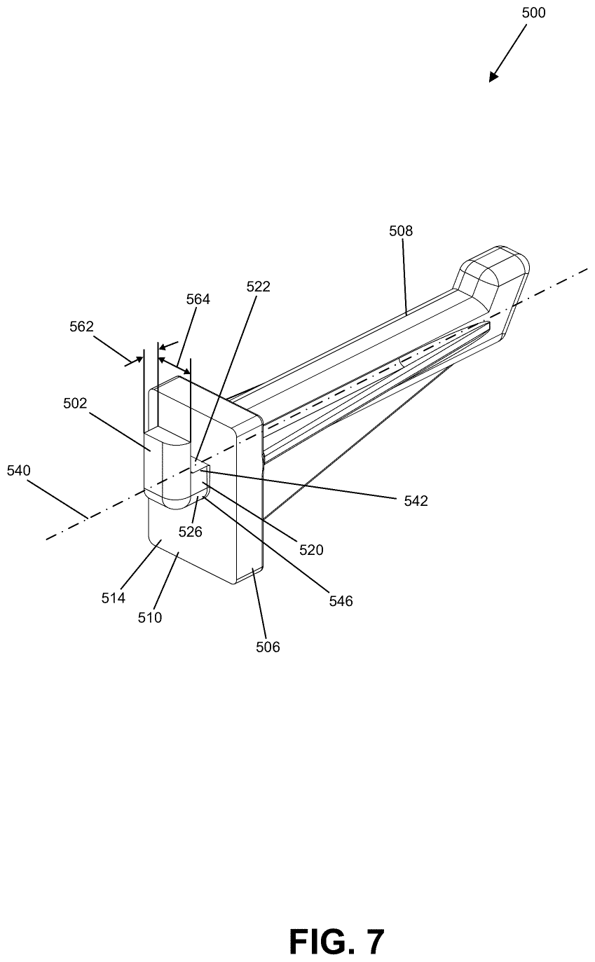

Referring to FIG. 6, an example of slatwall accessory 500 includes a mounting bracket or accessory mount 501 for connection with a load supporter 508 of the accessory and for releasably securing the accessory 500 to a slatwall. In the example illustrated, the load supporter 508 comprises an elongate hook. In other examples, the load supporter may comprise two spaced apart hook elements, a bin, a basket, a shelf, a rod for clothes hangers, or another supporter element.

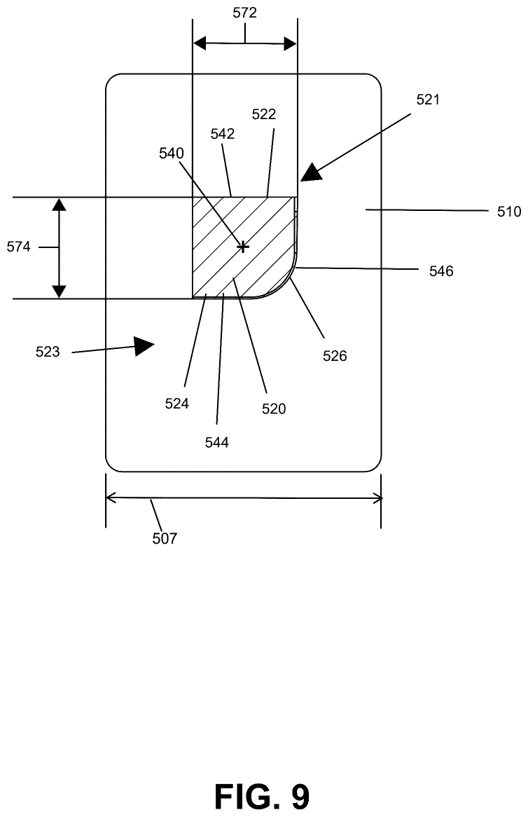

In the example illustrated, the accessory mount 501 includes a base 506 having a base width 507 (FIG. 9), and a base back surface 514 that includes an engagement portion for engaging a front face of the slatwall 304 adjacent the channel opening 333. The base 501 further defines a connection portion 512 disposed forward of the back surface 514 for connection with the load supporter 508.

In the example illustrated, the accessory mount 501 further includes a stem 520 protruding rearwardly from the back surface 514 along a stem axis 540. The stem 520 is fixed relative to the base 506, and has a stem width 572 perpendicular to the stem axis 540 and parallel to the base width 507 (FIG. 9). The stem further has a stem height 574 perpendicular to the stem width 572. In the example illustrated, the stem width and stem height are of equal size.

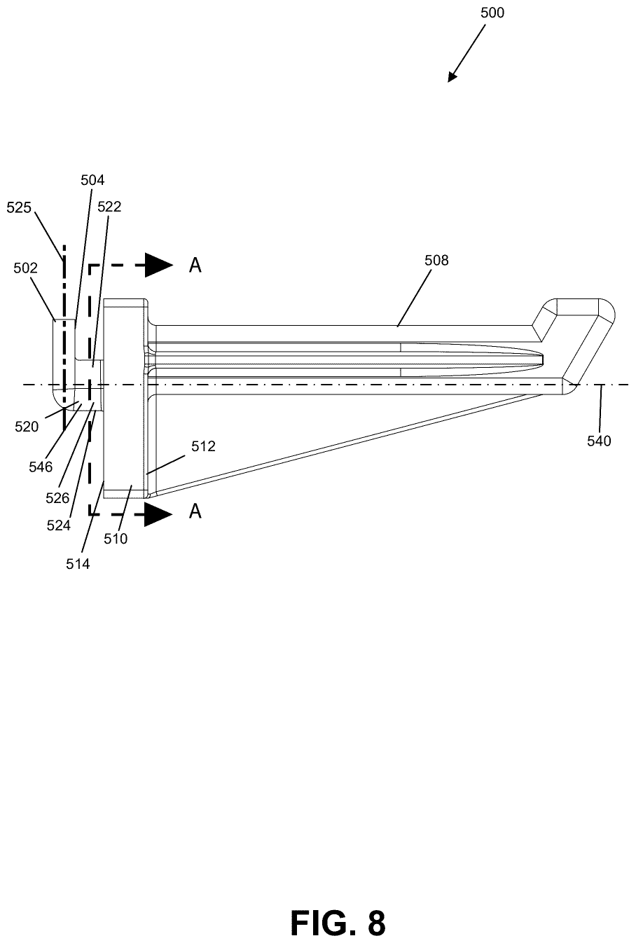

In the example illustrated, the accessory mount 501 further includes a retainer 502 protruding orthogonally from the stem 520 along a retainer axis 525 (FIG. 8). The retainer 502 is fixed relative to the stem 520, and has a retainer width 564 parallel to the stem width 572. The retainer 502 further includes a retainer abutment surface 504 directed forward, toward the base back surface. The retainer abutment surface 504 is spaced apart from the base back surface (in a direction parallel to the stem axis 540) by a retainer gap.

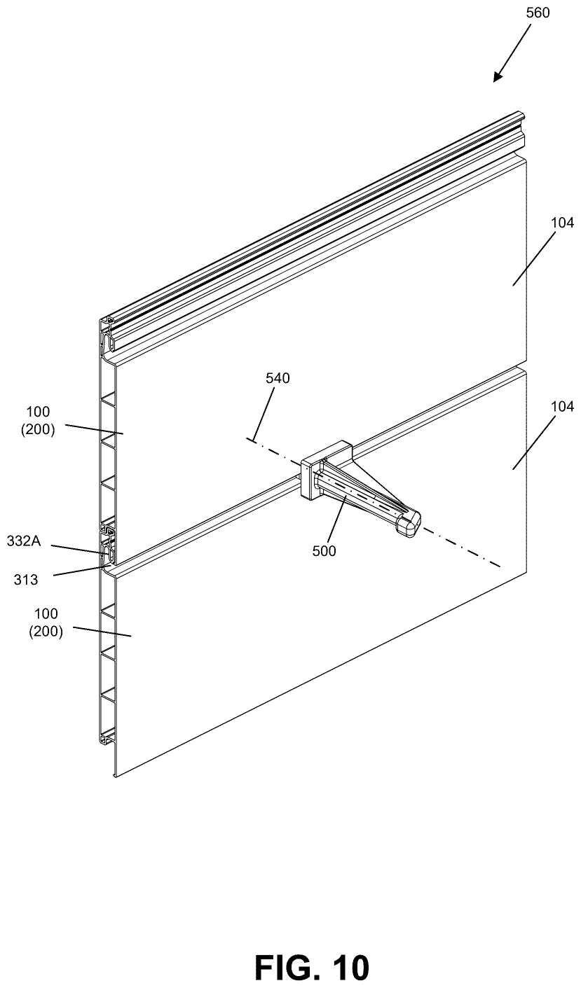

In the example illustrated, the retainer width 564 and the stem width 572 are sufficiently narrow for insertion of the of the retainer 502 and the stem 520 between the opening upper edge and the opening lower edge of the channel opening, when the retainer axis 525 is oriented parallel to the channel (e.g. oriented horizontally and parallel to the wall 10, in the example illustrated). The retainer and stem are, in the example illustrated, insertable through the channel opening in a front-to-rear direction (e.g. toward the wall 10) until the base back surface engages the front surface of the slatwall adjacent the channel opening, at which point the mount 501 is in a partially installed position (see FIG. 10). In some examples, the channel opening is about 9.5 mm (e.g. a ⅜ inch opening), and the stem width 572 and retainer width 564 can also be about 9.5 mm for insertion into the channel opening.

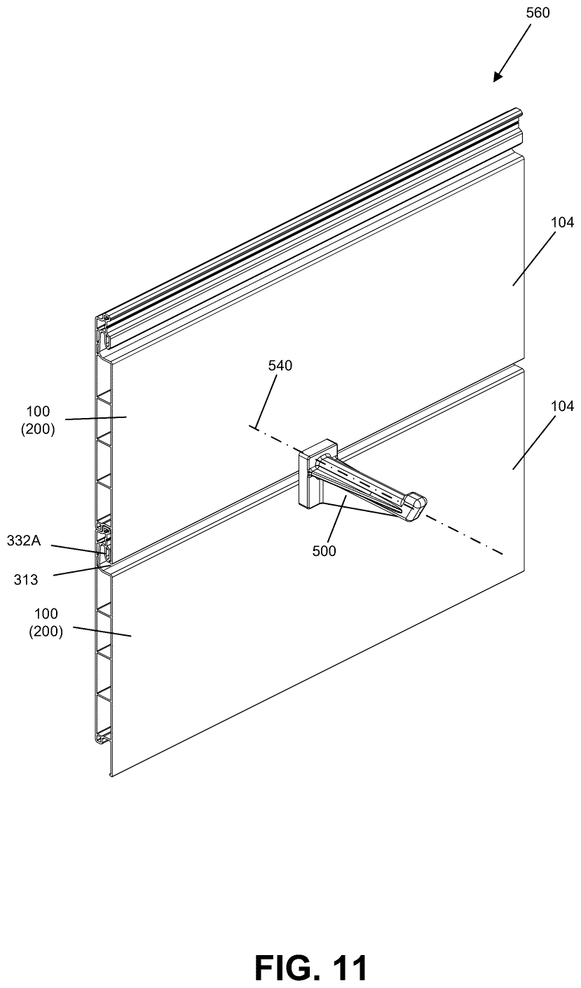

The accessory mount 501 is rotatable from the partially installed position to a fully installed position in which retainer axis 525 is oriented perpendicular to the channel 313 and at least a lower portion of the flange 350 is received in the retainer gap. When in the fully installed position (FIG. 11), the retainer abutment surface bears against the flange inner surface of the flange 350 to prevent removal of the mount 501 in a forward direction (e.g. away from the wall 10).

In the example illustrated, rotation from the partially installed position (FIG. 10) to the fully installed position (FIG. 11) generally includes rotating the mount 501 a quarter turn (90 degrees) about the stem axis 540 in a clockwise direction (when looking at the front of the wall. Rotation from the fully installed position to the partially installed position includes, in the example illustrated, a quarter turn rotation in the opposite (counter-clockwise direction). This rotation is facilitated by the fact that, in the example illustrated, the base width is greater than the retainer width and the stem width, and is greater than spaced between the upper and lower edges of the channel opening, so that the base is non-insertable into the channel opening. The enlarged base provides engagement of the base back surface when the accessory mount is in and moved between the partially installed and the fully installed positions. This can help ensure accurate front-to-back alignment between the flange and the retainer gap, and between the retainer and the vertical recess portion of the channel behind the flange.

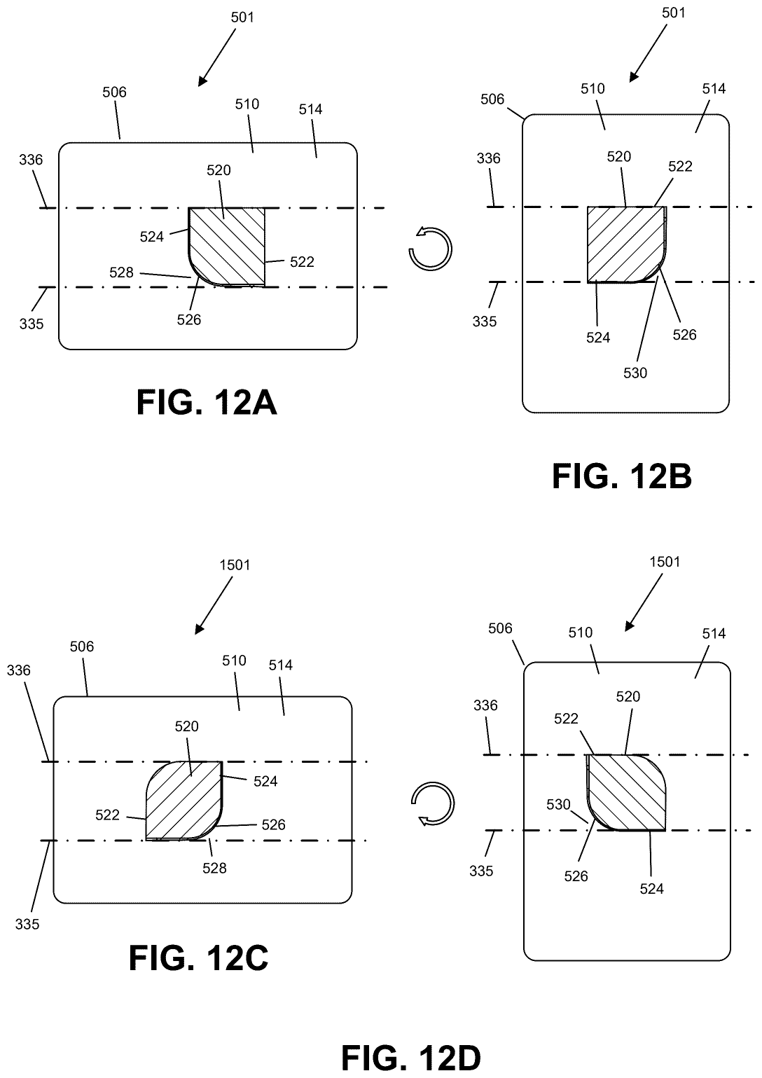

In the example illustrated, the stem 520 further includes a planar lower abutment surface 544 for flush engagement with the lower bearing surface (e.g. surface 334, 335 in FIG. 5) of the channel 313 when the accessory mount is in the fully installed position (see FIGS. 9 and 12B). This engagement inhibits downward displacement of the accessory mount 501 relative to the slatwall when the mount 501 is in the fully installed position.

In some examples, at least one of the stem and the retainer comprise a planar upper abutment surface for flush engagement with an upper bearing surface of the channel when the mount 501 is in the fully installed position. In the example illustrated, the stem 520 of the mount 501 includes a planar upper abutment surface 542 opposite the planar lower abutment surface 544 for engaging an upper bearing surface (e.g. surface 336 in FIG. 5) opposite the lower bearing surface (334, 335) at the channel opening 333 of the channel 313.

In some examples, the accessory mount may include at least one rotation-enabling surface to facilitation rotation of the mount between the upper and lower channel bearing surfaces. In the example illustrated, the mount 501 includes a lower rotation-enabling surface 526 in the form of a chamfered corner 546 (FIG. 9). The lower rotation-enabling surface 526 is spaced apart from the stem axis 540 by a distance that is less than or equal to the shortest distance between the lower abutment surface and the stem axis 540. The lower rotation-enabling surface allows rotation between the partially installed position (FIG. 12A) and the fully installed position (FIG. 12B) by removing material so that the lower rotation-enabling surface does not interfere with the lower bearing surface 335.

In some examples, the accessory mount may include an upper rotation-enabling surface as an alternative to, or in addition to, the lower rotation-enabling surface. An example of a stem 520 with an upper rotation-enabling surface and a lower rotation-enabling surface is illustrated in FIGS. 12C and 12D. The upper rotation-enabling surface avoids interference with the upper bearing surface 336 during rotation between the partial and fully installed positions 12C, 12D.

In some examples, the mount may include one or more rotation-limiting surfaces. In the example illustrated, the upper abutment surface 542 includes an upper rotation-limiting surface 522 (FIG. 9) for preventing further rotation of the accessory mount about the stem axis 540 in a direction away from the partially installed position when the mount 501 is in the fully installed position. The upper rotation-limiting surface 522 is disposed at a greater distance from the stem axis 540 than a central portion of the upper abutment surface, and in the example illustrated (as viewed in FIG. 12B), the upper rotation-limiting surface 522 is coplanar with the central portion of the surface 542 and extends outward to the top-right corner of the stem 520.

In the example illustrated, the lower abutment surface 544 includes a lower rotation-limiting surface 524 (FIG. 9) for preventing further rotation of the accessory mount about the stem axis 540 in a direction away from the partially installed position when the mount 501 is in the fully installed position. The lower rotation-limiting surface 524 is disposed at a greater distance from the stem axis 540 than a central portion of the lower abutment surface, and in the example illustrated (as viewed in FIGS. 9 and 12B), the lower rotation-limiting surface 524 is coplanar with the central portion of the surface 544 and extends outward to the bottom-left corner of the stem 520. The cross-section dimension of the stem 520 measured along the diagonal between the corners with the rotation-limiting surfaces (top-right to bottom-left in FIG. 12B) is greater than the vertical distance between the lower and upper bearing surfaces 335, 336 so that further rotation (in a counter-clockwise direction as viewed from the back in FIG. 12B) is not possible.

In some embodiments, for example, the arcuate surface portion 546 of the rotation-enabling surface 526 has a radius of curvature having a minimum value of at least about ⅛ inches (3.1 mm).

In some embodiments, for example, the intermediate member 520 and the retainer 502 are co-operatively configured to define an L-shape member. That is, in some embodiments, for example, the retainer 502 is disposed on one side of the intermediate member 520, such as a first side. In some embodiments, for example, the intermediate member 520 and the retainer 502 are co-operatively configured to define a T-shape member. That is, in some embodiments, for example, a portion of the retainer 502 is disposed on a first side of the intermediate member 502, such as the first side, and another portion of the retainer 502 is disposed on a second side of the intermediate member 502 that is opposite the first side.

In the example illustrated, the elements of the mount 501 including the base, the stem 520, and the retainer 502 are of integral, unitary, one-piece construction. In some embodiments, the load supporter and the mount 501 are of unitary, integral, one-piece construction.

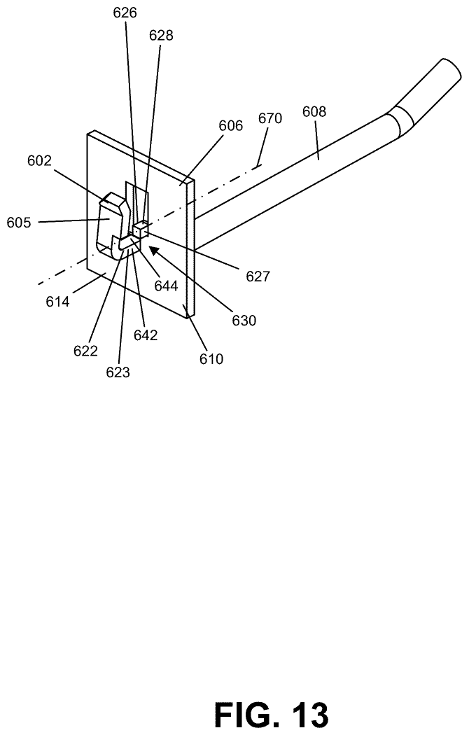

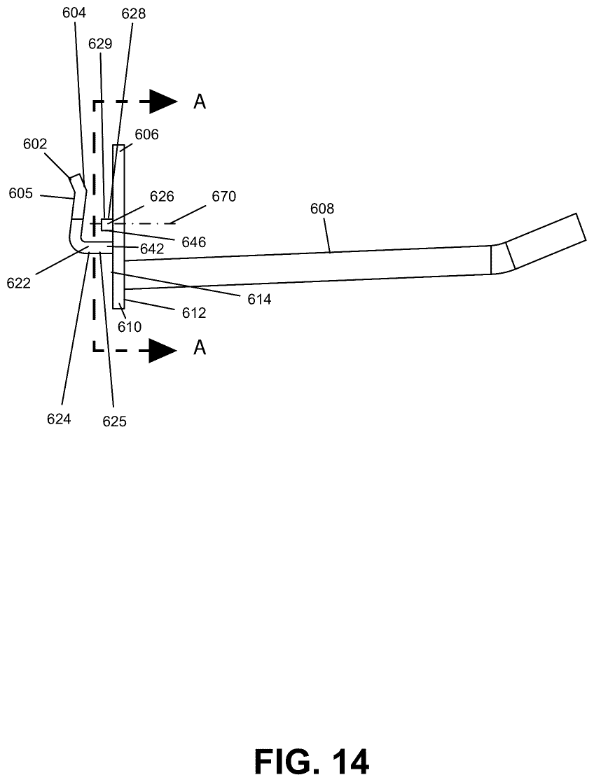

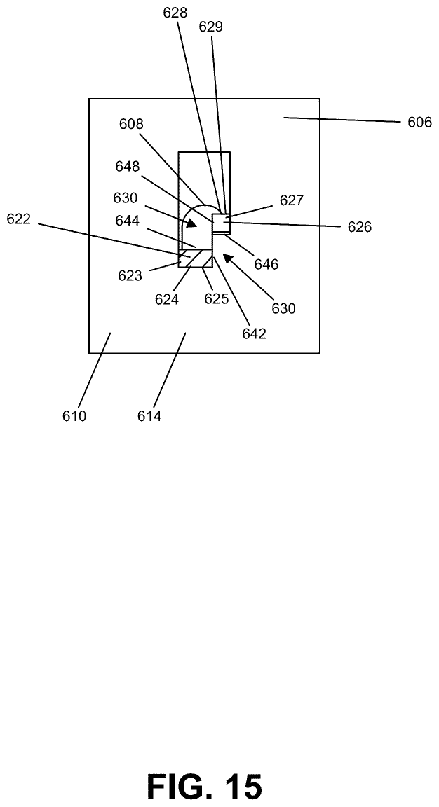

Referring to FIGS. 13-18, another example of a slatwall accessory 600 with a mount 601 is disclosed. The mount is similar to the mount 501, and supports a load supporter 608 connected to the base 606, and is releasably securable to a slatwall 304. In the example illustrated, the mount 601 is formed of a stamped metal, and includes a base 606, a stem 620, and a retainer 602. The stem protrudes rearward from a rear surface of the base, and the retainer protrudes orthogonally from the stem behind the base.

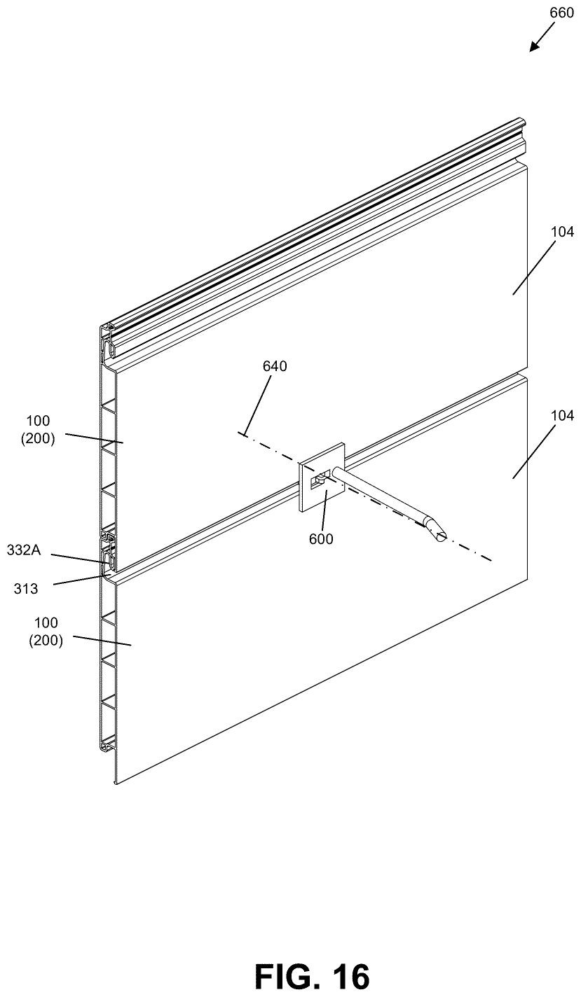

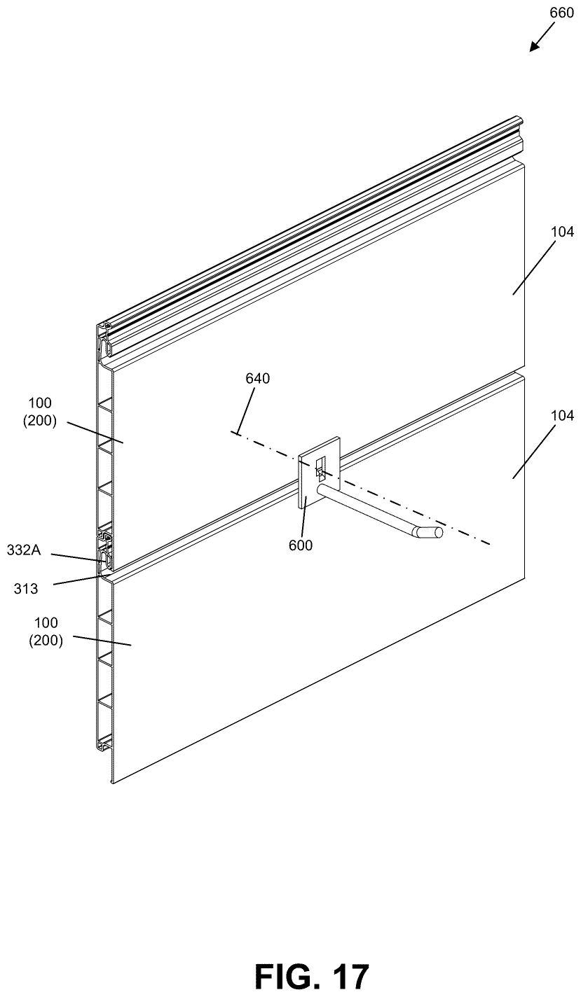

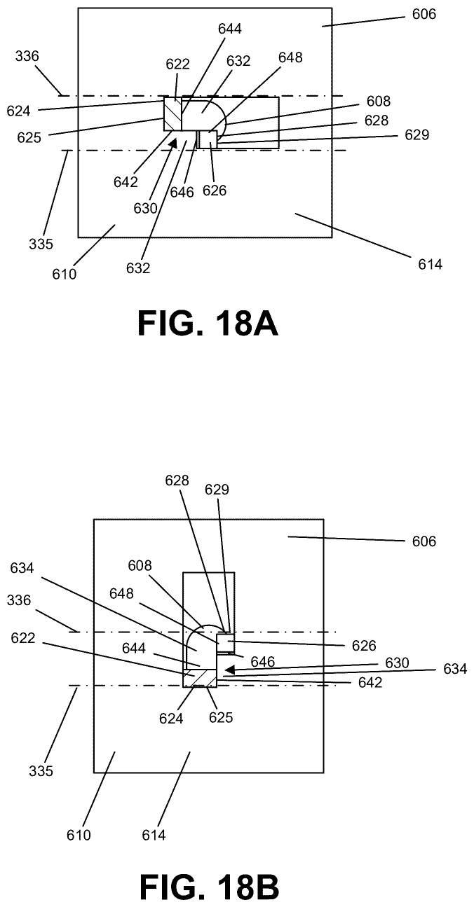

The retainer 602 and stem are insertable into the channel opening when the retainer is oriented parallel to the channel (horizontally, in the example illustrated). The mount 601 is rotatable between a partially installed position (FIG. 16) and a fully installed position (FIGS. 17 and 18B).

The retainer 602 includes a retainer abutment surface 604 directed toward, and spaced apart form the base back surface.

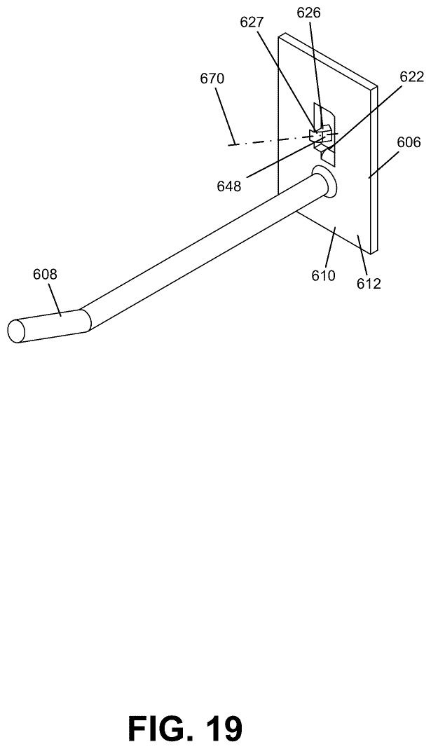

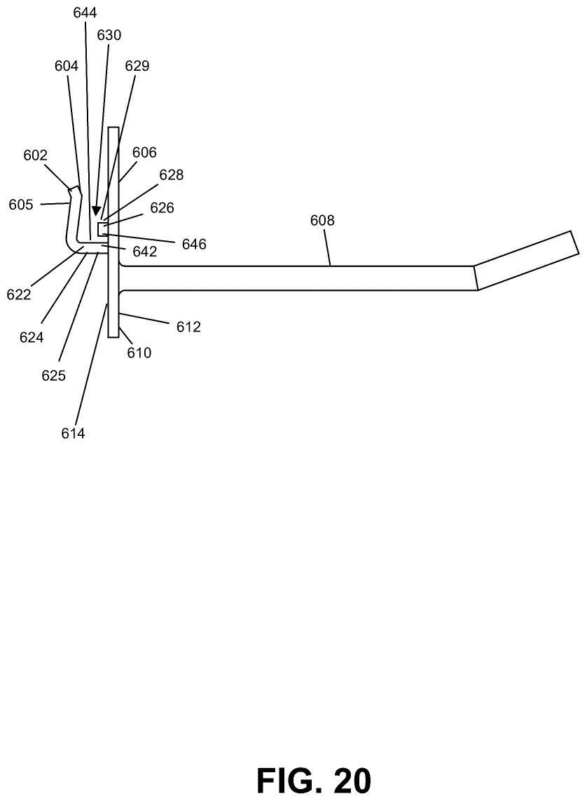

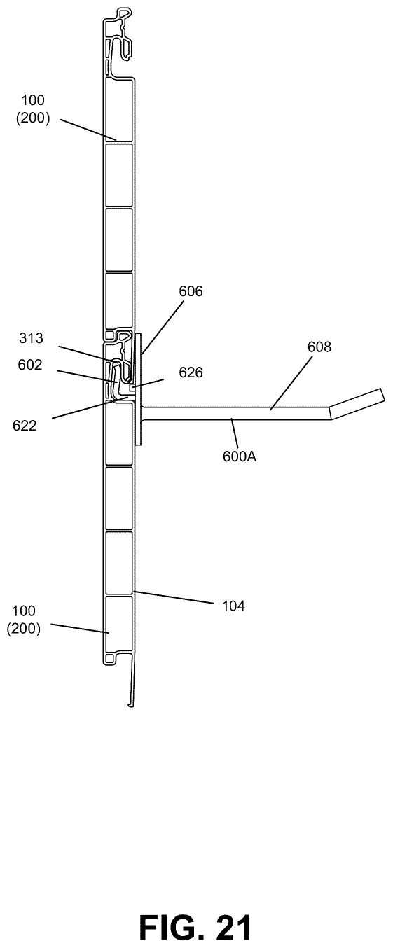

Referring to FIGS. 19-21, a mounting assembly 600A is an alternate embodiment of the mounting assembly 600. As depicted, the mounting assembly 600A substantially corresponds to the mounting assembly 600, but with some differences. For example, the longitudinal axis 670 of the second retention counterpart 626 and the normal axis defined by the front surface 612 of the flange 610 are disposed in a non-parallel relationship.

In some embodiments, for example, the acute angle defined between the longitudinal axis 670 of the second retention counterpart 626 and the normal axis defined by the front surface 612 of the flange 610 has a minimum value of at least 5 degrees, for example, at least 15 degrees, for example, at least 30 degrees, for example, at least 45 degrees. In some embodiments, for example, the acute angle defined between the longitudinal axis 670 of the second retention counterpart 626 and the normal axis defined by the front surface 612 of the flange 610 has a value of 45 degrees. In some embodiments, for example, the acute angle defined between the longitudinal axis 670 of the second retention counterpart 626 and the normal axis defined by the front surface 612 of the flange 610 has a value of greater than 45 degrees.

In some embodiments, for example, similar to the mounting assembly 600, the retainer 602, the first retention counterpart 622, and the second retention counterpart 626 of the mounting assembly 600A are manufactured by stamping the material of the flange 610. In some embodiments, for example, the material of the flange 610 includes metal, such as aluminum or steel. In such embodiments, for example, the material of the retainer 602, the first retention counterpart 622, and the second retention counterpart 626 includes metal. In some embodiments, for example, as depicted, the retainer 602 and the first retention counterpart 622 are stamped from a first portion of material of the flange 610, and the second retention counterpart 626 is stamped from a second portion of material of the flange 610 that is different from the first portion of material of the flange 610. In some embodiments, for example, the first portion of material of the flange 610 and the second portion of material of the flange 610 are disposed in a side-by-side relationship. In such embodiments, for example, the retainer 602 has a width, measured along an axis that is parallel to a horizontal or lateral axis (e.g. an axis that is perpendicular to a normal axis defined by the first rotation-opposing surface 624, for example, the planar surface portion 625 of the first rotation-opposing surface 624, and also perpendicular to a longitudinal axis of the first retention counterpart 622), having a maximum value that is the same as the maximum value of the width of the first retention counterpart 626, measured along an axis that is parallel to a horizontal or lateral axis (e.g. an axis that is perpendicular to a normal axis defined by the first rotation-opposing surface 624, for example, the planar surface portion 625 of the first rotation-opposing surface 624, and also perpendicular to a longitudinal axis of the first retention counterpart 622).

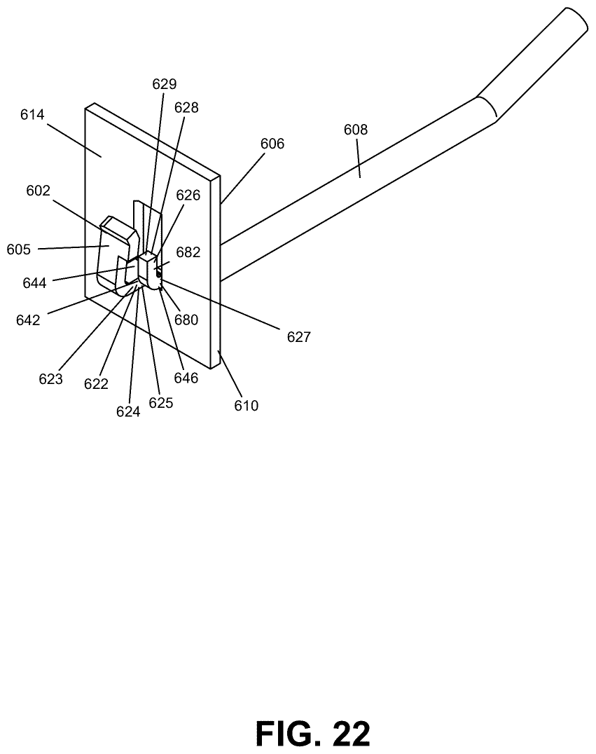

Referring to FIG. 22, a mounting assembly 600B that is an alternate embodiment of the mounting assembly 600, substantially corresponds to the mounting assembly 600 but with some differences. For example, the second retention counterpart 626 comprises a horizontal member 680 and a vertical member 682. As depicted, the horizontal member 680 is connected to the flange 610 and extends rearwardly from the flange 610, and the vertical member 682 is connected to the horizontal member 680 and extends vertically from the horizontal member 680. In some embodiments, for example, the horizontal member 680 and the vertical member 682 are co-operatively configured to define an L-shaped member.

In some embodiments, the connection of the horizontal member 680 to the flange 610 is such that the longitudinal axis of the horizontal member 680 and the normal axis defined by the front surface 612 of the flange 610 are disposed in a parallel relationship.

In some embodiments, for example, the connection of the horizontal member 680 to the flange 610 is such that the longitudinal axis of the horizontal member 680 and the normal axis defined by the front surface 612 of the flange 610 are disposed in a non-parallel relationship. In some embodiments, for example, the angle defined between the longitudinal axis of the horizontal member 680 and the normal axis defined by the front surface 612 of the flange 610 has a minimum value of at least 5 degrees, for example, at least 15 degrees, for example, at least 30 degrees, for example, at least 45 degrees. In some embodiments, for example, the angle defined between the longitudinal axis of the horizontal member 680 and the normal axis defined by the front surface 612 of the flange 610 has a value of 45 degrees. In some embodiments, for example, the angle defined between the longitudinal axis of the horizontal member 680 and the normal axis defined by the front surface 612 of the flange 610 has a value of greater than 45 degrees.

In some embodiments, for example, the connection of the vertical member 682 to the horizontal member 680 is such that the longitudinal axis of the vertical member 682 and the longitudinal axis of the horizontal member 680 are disposed in a perpendicular relationship.

In some embodiments, for example, the connection of the vertical member 682 to the horizontal member 680 is such that the longitudinal axis of the vertical member 682 and the longitudinal axis of the horizontal member 680 are disposed in a non-parallel relationship. In some embodiments, for example, the angle defined between the longitudinal axis of the vertical member 682 and the longitudinal axis of the horizontal member 680 has a minimum value of at least 5 degrees, for example, at least 15 degrees, for example, at least 30 degrees, for example, at least 45 degrees. In some embodiments, for example, the angle defined between the longitudinal axis of the vertical member 682 and the longitudinal axis of the horizontal member 680 has a value of 90 degrees.

In some embodiments, for example, the longitudinal axis of the first retention counterpart 622 and the longitudinal axis of the horizontal member 680 are disposed in a parallel relationship. In some embodiments, for example, the longitudinal axis of the first retention counterpart 622 and the longitudinal axis of the horizontal member 680 are disposed in a non-parallel relationship. In some embodiments, for example, the angle defined between the longitudinal axis of the first retention counterpart 622 and the longitudinal axis of the horizontal member 680 has a minimum value of at least 5 degrees, for example, at least 15 degrees, for example, at least 30 degrees, for example, at least 45 degrees.

In some embodiments, for example, the first rotation-opposing surface 626 and the bottom surface of the horizontal member 680 are disposed in a parallel relationship.

In some embodiments, for example, second retention counterpart 626, in particular, the horizontal member 680 and the vertical member 682, are disposed forwardly of the retainer 602, for example, disposed forwardly of the forwardly-disposed retainer-defined surface 604.

In some embodiments, for example, the surface 646 of the second retention counterpart 626 is defined by the bottom surface of the horizontal member 680. In some embodiments, for example, the second rotation-opposing surface 628 is defined by the upper surface of the vertical member 682. In some embodiments, for example, the second rotation-opposing surface 628 is defined at the free end of the vertical member 682. In some embodiments, for example, the surface 648 is defined by the side surface of the vertical member 682. In some embodiments, for example, the surface 648 is defined by the side surface of the horizontal member 680. In some embodiments, for example, the surface 648 is defined by the side surface of the vertical member 682 and the side surface of the horizontal member 680.

In some embodiments, for example, the surface 642 of the first retention counterpart 622 and the horizontal member 680 are disposed in opposing relationship. In some embodiments, for example, the bottom surface of the horizontal member 680 and the first rotation-opposing surface 626 are disposed on a common plane. In some embodiments, for example, each one of the bottom surface of the horizontal member 680 and the first rotation-opposing surface 626, independently, is coincident with a common plane. In some embodiments, for example, the bottom surface of the horizontal member 680 is laterally offset relative to the first rotation-opposing surface 626, and there is an absence of a vertical offset of the bottom surface of the horizontal member 680 relative to the first rotation-opposing surface 626. In such embodiments, for example, the space-defining configuration 630 of the mounting assembly 600B defines a space defined between the surface 644 of the first retention counterpart 622 and the surface 648 of the second retention counterpart 626, to effectuate the clearance between the mounting assembly 600B and the upper and lower surface portions 336, 335 of the panel 100 (200), such that the mounting assembly 600B is rotatable, relative to the panel 100 (200). In some embodiments, for example, there is an absence of definition of a space by the space-defining configuration 630 of the mounting assembly 600B, between the surface 642 of the first retention counterpart 622 and the surface 646 of the second retention counterpart 626, to effectuate the clearance between the mounting assembly 600B and the upper and lower surface portions 336, 335 of the panel 100 (200), such that the mounting assembly 600B is rotatable, relative to the panel 100 (200), due to the absence of a vertical offset of the bottom surface of the horizontal member 680 relative to the first rotation-opposing surface 626.

In some embodiments, for example, while: (i) the received configuration 660 is established by the mounting assembly 600B and the panel 100 (200), the space-defining configuration 630 and the upper surface portion 336 are co-operatively configured to define the clearance space between the mounting assembly 600B and the panel 100 (200), such as the first space 632 and the second space 634, such that the mounting assembly 600B is rotatable, relative to the panel 100 (200), in the retention direction (e.g. in a clockwise direction) or the release direction (in a counter clockwise direction), for effectuating the transitioning of the received configuration 660 to the retention-effective relationship or release-effective relationship, in a manner substantially similar to the manner as described herein with respect to the received configuration 660 defined by the mounting assembly 600 and the panel 100 (200).

In some embodiments, for example, the relative disposition of the first retention counterpart 622 and the second retention counterpart 626 of the mounting assembly 600B affects which one of the opening-defining surface portions 335, 336 co-operates with the space-defining configuration 630 of the mounting assembly 600B, for defining the clearance space between the mounting assembly 600B and the panel 100 (200), such as the first space 632 and the second space 634, and further affects the direction of rotation of the mounting assembly 600B, relative to the panel 100 (200), to effectuate the transition of the received configuration 660 from the release-effective relationship to the retention-effective relationship, in a manner substantially similar to the manner with respect to the received configuration 660 defined by the mounting assembly 600 and the panel 100 (200) as described herein.

In some embodiments, for example, the retainer 602, the first retention counterpart 622, and the second retention counterpart 626 of the mounting assembly 600B are manufactured by stamping the material of the flange 610. In some embodiments, for example, the material of the flange 610 includes metal, such as aluminum or steel. In such embodiments, for example, the material of the retainer 602, the first retention counterpart 622, and the second retention counterpart 626 includes metal. In some embodiments, for example, as depicted, the retainer 602, the first retention counterpart 622, and the second retention counterpart 626 are stamped from a common portion of material of the flange 610. In such embodiments, for example, the retainer 602 has a width, measured along an axis that is parallel to a horizontal or lateral axis (e.g. an axis that is perpendicular to a normal axis defined by the first rotation-opposing surface 624, for example, the planar surface portion 625 of the first rotation-opposing surface 624, and also perpendicular to a longitudinal axis of the first retention counterpart 622), having a maximum value that is greater than the maximum value of the width of the first retention counterpart 626, measured along an axis that is parallel to a horizontal or lateral axis (e.g. an axis that is perpendicular to a normal axis defined by the first rotation-opposing surface 624, for example, the planar surface portion 625 of the first rotation-opposing surface 624, and also perpendicular to a longitudinal axis of the first retention counterpart 622).

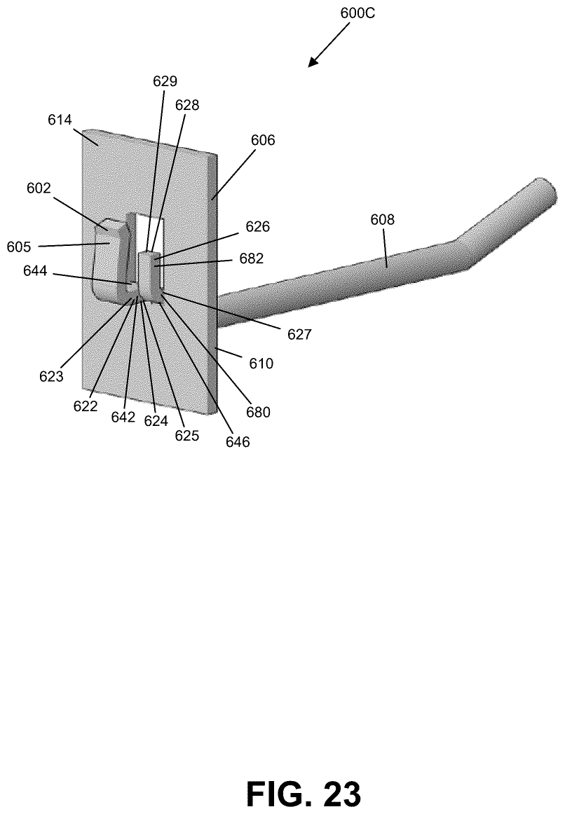

FIG. 23 depicts a mounting assembly 600C that is an alternate embodiment of the mounting assembly 600B. The mounting assembly 600C substantially corresponds to the mounting assembly 600B, except the retainer 602 and the first retention counterpart 622 are stamped from a first portion of material of the flange 610, and the second retention counterpart 626 is stamped from a second portion of material of the flange 610 that is different from the first portion of material of the flange 610. In some embodiments, for example, the first portion of material of the flange 610 and the second portion of material of the flange 610 are disposed in a side-by-side relationship. In such embodiments, for example, the retainer 602 has a width, measured along an axis that is parallel to a horizontal or lateral axis (e.g. an axis that is perpendicular to a normal axis defined by the first rotation-opposing surface 624, for example, the planar surface portion 625 of the first rotation-opposing surface 624, and also perpendicular to a longitudinal axis of the first retention counterpart 622), having a maximum value that is the same as the maximum value of the width of the first retention counterpart 626, measured along an axis that is parallel to a horizontal or lateral axis (e.g. an axis that is perpendicular to a normal axis defined by the first rotation-opposing surface 624, for example, the planar surface portion 625 of the first rotation-opposing surface 624, and also perpendicular to a longitudinal axis of the first retention counterpart 622). In some embodiments, for example, the material of the flange 610 includes metal, such as aluminum or steel. In such embodiments, for example, the material of the retainer 602, the first retention counterpart 622, and the second retention counterpart 626 includes metal.

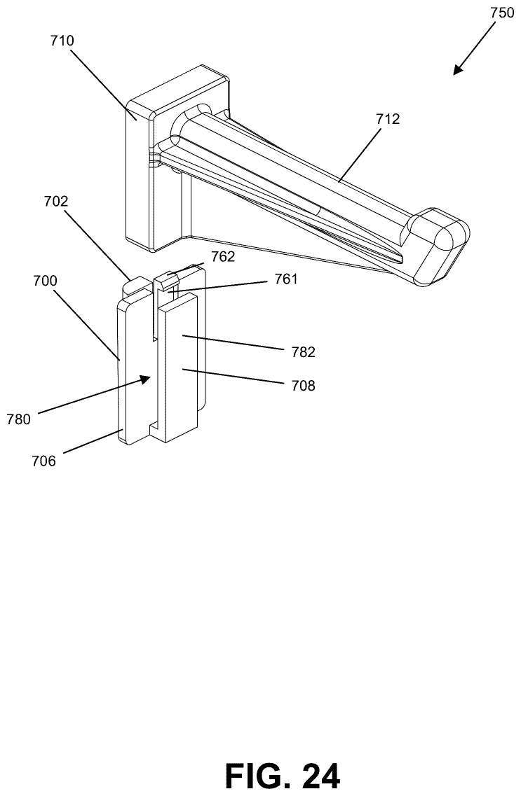

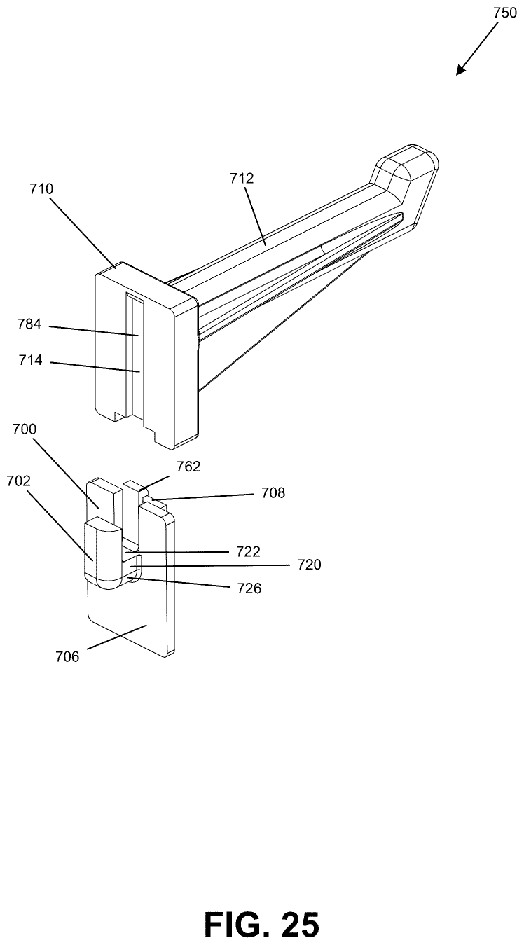

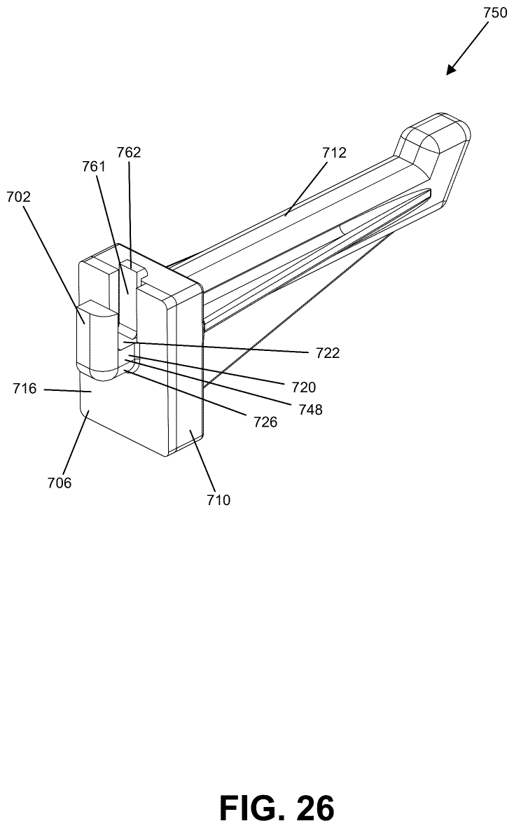

Referring to FIGS. 24-26, an alternate example of an accessory 750 has an accessory mount like the mount 501, but the accessory mount is releasably securable to a load supporter 712. The accessory mount

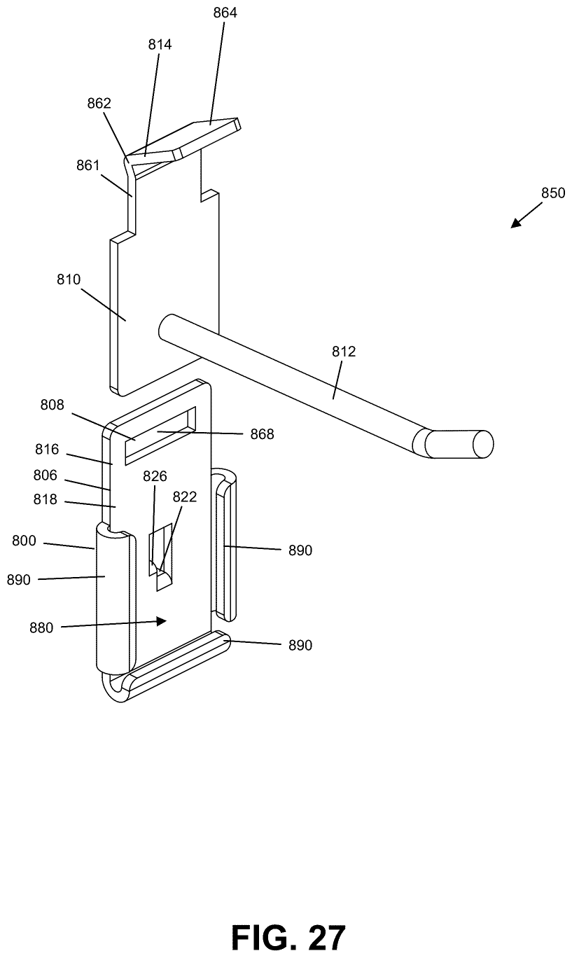

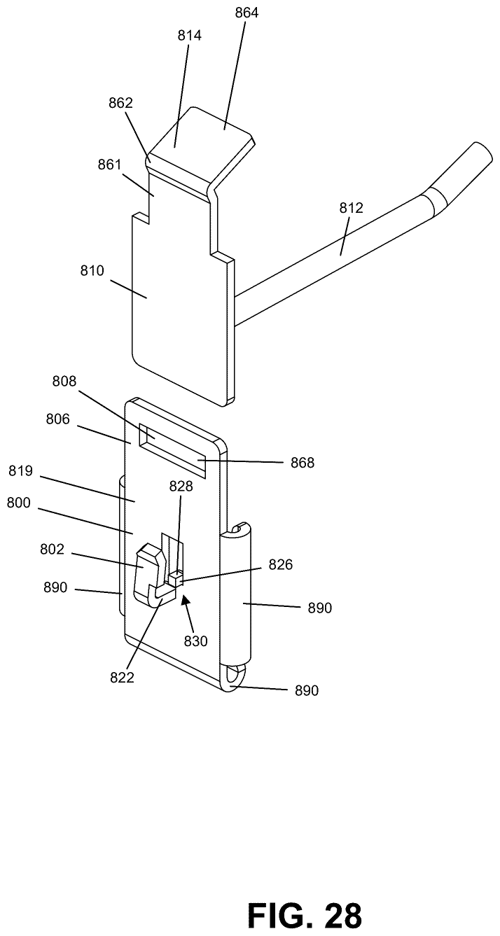

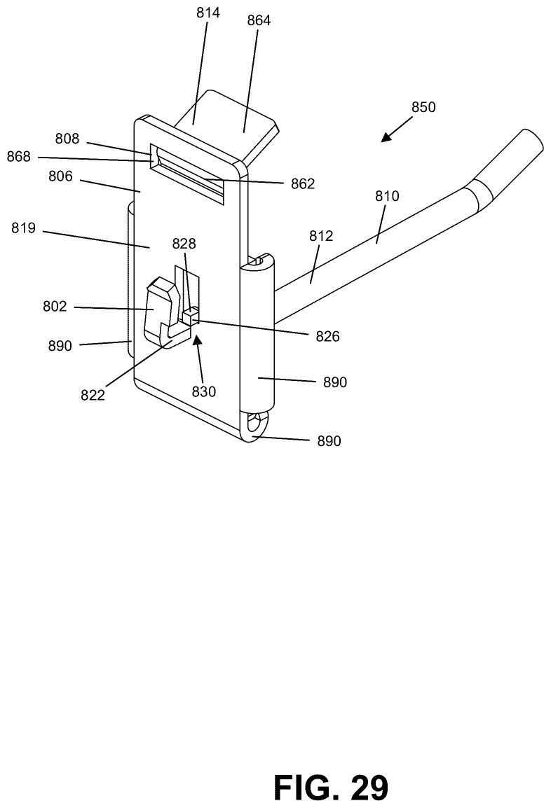

Referring to FIGS. 27-29, an alternate example of an accessory 850 has an accessory mount like the mount 601, but the accessory mount is releasably securable to the load supporter 812.

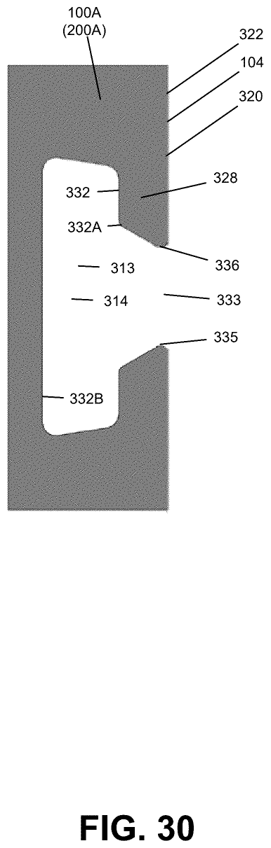

FIG. 30 depicts a panel 200 that is an alternate embodiment of the panel 100. In some embodiments, for example, the material of the panel 200 includes medium density fiberboard (MDF). Similar to the panel 100, the panel 200 is configured for covering at least a portion of a surface of a wall 10. Similar to the panel 100, the panel 200 is configured for coupling to the wall 10 with fasteners 402, such that the covering of at least a portion of a surface 12 of the wall 10 is effectuated. Similar to the panel 100, the front surface 104 of the panel 200 defines a visible surface 320, which, in some embodiments, includes the planar surface 322.

In some embodiments, for example, the panel 200 is configured to define a first panel 200A for coupling to a second panel 200B, such that an assembled configuration 300 is established. Similar to the panel 100, the first panel 200A includes coupling counterparts configured for coupling with corresponding coupling counterparts of the second panel 200B for establishing first and second coupled configurations.

As depicted, similar to the panel 100, the panel 200 includes a receiving space-defining portion 328 that defines a recess-defining surface 334. In some embodiments, for example, the recess-defining surface 334 defines the recess 313 and the mounting assembly-receiving space 314. As depicted, similar to the panel 100, the recess-defining surface 334 defines the retaining surface configuration 332 that includes the forwardly-disposed retaining surface portion 332A and the rearwardly-disposed retaining surface portion 332B, and further defines the upper and lower surface portions 336 and 335 which co-operate to define the opening 333 of the panel 200.

In some embodiments, for example, as depicted in FIG. 30, the longitudinal cross-section of the recess-defining surface 334 of the panel 200 has a T-shape. In some embodiments, for example, as depicted in FIG. 99, the recess 313 and the space 314 have a T-shape. In this respect, the recess 313 is a T-shaped recess 313 and the space 314 is a T-shaped space 314.

In some embodiments, for example, the mounting assemblies described herein are configured to co-operate with the panel 200, in particular, are configured to co-operate with the recess-defining surface 334 of the panel 200, which includes the retaining surface configuration 332 and the upper and lower surface portions 336, 335, to establish the received configuration, to effectuate disposition of the received configuration in the release-effective relationship and the retention-effective relationship, and to transition between the release-effective relationship and the retention-effective relationship, in a manner substantially similar to the manner as described herein with respect to the mounting assemblies described herein, such as mounting assemblies 500, 600, 600A, 600B, or 600C, and the panel 100.

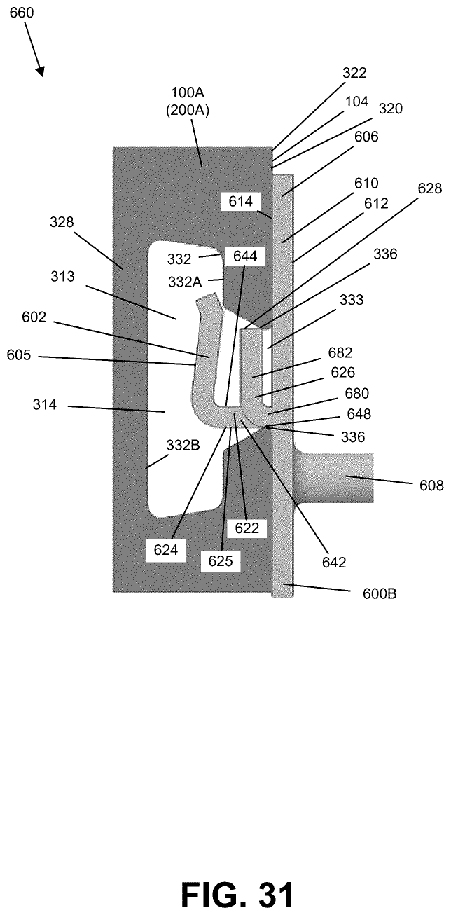

For example, FIG. 31 depicts a received configuration 660 established by the mounting assembly 600B and the panel 200 wherein the received configuration 660 is disposed in the retention-effective relationship. As depicted, while the received configuration 660 is established and disposed in the retention-effective relationship, the first rotation-opposing surface 624 and the lower surface portion 335 of the panel 200 are disposed in opposing relationship (e.g. abutting relationship), and the second rotation-opposing surface 628 and the upper surface portion 336 of the panel 200 are disposed in opposing relationship (e.g. abutting relationship), such that rotation of the mounting assembly 600B, relative to the panel 200, in the retention direction, is opposed (e.g. prevented).

In some embodiments, for example, the mounting assemblies described herein are configured to co-operate with the recess-defining surface 334 of the panel 100, which include the upper and lower surface portions 336 and 335 that define the opening 333 of the panel 100, for example, for defining the received configuration, such as the received configuration 560, 660, and for effectuating the transitioning of the received configuration between the release-effective relationship and the retention-effective relationship. The mounting assemblies described herein are also configured to co-operate with panels having different embodiments of the recess 313 (e.g. panels with recesses 313 of varying shapes, such as the panel 100A which includes a T-shaped recess 313) to define the received configuration, and for effectuating the transitioning of the received configuration between the release-effective relationship and the retention-effective relationship. In some embodiments, for example, the mounting assemblies described herein are co-operable with panels having different embodiments of the recess 313, so long as the co-operative configuration of the upper and lower surface portions 336, 335 of the panels are consistent across the panels (e.g. the minimum spacing distance between the upper and lower surface portions 336, 335 is the same across the panels). Further, in some embodiments, for example, the design of the retainers of the mounting assemblies described herein, such as the retainer 502, 602 (e.g. shape of the retainer, relative disposition of the retainer to the intermediate member of the mounting assembly 500 or to the first and second retention counterparts 622, 626 of the mounting assembly 600, etc.) can be varied, and the design of the internal portion of the recess 313 of the different panels can be similarly varied, and the mounting assemblies described herein are still co-operable with panels to define the received configuration, so long as the intermediate member 520 or first and second retention counterparts 622, 626 are co-operable with the upper and lower surface portions 336, 335 (e.g. the opening-defining surfaces of the panels) to define the rotatability of the mounting assembly, relative to the panels. In some embodiments, for example, to design different embodiments of the mounting assemblies described herein, the design of the intermediate member 520 and the design of the first and second retention counterparts 622, 626 can be unchanged, and the other components of the mounting assemblies can be re-designed (e.g. the retainer or the load supporting configuration), and the different embodiments of the mounting assemblies described herein are co-operable with the panel 100 (200) or the panel 100A (200A) to define the received configuration, since the design of the intermediate member 520 of the mounting assembly 500 and the design of the first and second retention counterparts 622, 626 are unchanged, and the intermediate member 520 or first and second retention counterparts 622, 626 co-operate with the upper and lower surface portions 336, 335 to define the rotatability of the mounting assembly relative to the panel 100 (200) or the panel 100A (200A) for effectuating the transitioning of the received configuration between the release-effective relationship and the retention-effective relationship.

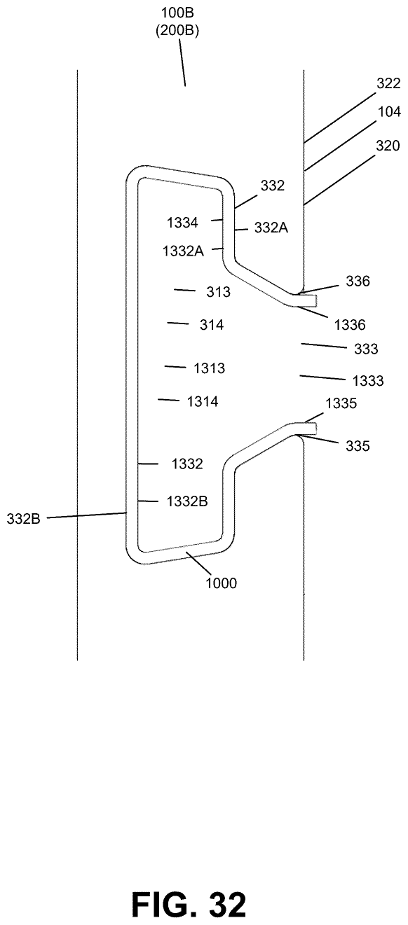

FIG. 32 depicts a panel 100B (200B) substantially similar to the panel 200, having a T-shaped recess 313, and wherein a reinforcing insert 1000 disposed in the recess 313 of the panel 100B (200B). The reinforcing insert 1000 is configured to improve the strength of the panel 100B, for example, the receiving space-defining portion 328. In some embodiments, for example, the material of the insert 1000 is stronger than the material of the panel 100B. In some embodiments, for example, the material of the panel 100B includes medium density fiberboard (MDF), and the material of the insert 1000 is metal, such as aluminum or steel. In some embodiments, for example, while the insert 1000 is disposed in the recess 313, the panel 100B (200B) and the insert 1000 are connected together via friction fit or interference fit. In some embodiments, for example, while the insert 1000 is disposed in the recess 313, the panel 100B (200B) and the insert 1000 are disposed in abutting engagement.

The insert 1000 defines a recess-defining surface 1334, which functions like the recess-defining surface 334 of the panel 100 (200) or the panel 100A (200A), to define a recess 1313 and a mounting assembly-receiving space 1314 of the insert 1000, substantially similar to the recess 313 and the mounting assembly-receiving space 314 of the panel 100 (200) or the panel 100A (200A), for receiving any of the mounting assemblies described herein. As depicted, similar to the panel 100 (200) and the panel 100A (200A), the recess-defining surface 1334 of the insert 1000 defines a retaining surface configuration 1332 that includes a forwardly-disposed retaining surface portion 1332A and a rearwardly-disposed retaining surface portion 1332B, which function like the forwardly-disposed retaining surface portion 332A and the rearwardly-disposed retaining surface portion 332B of the panel 100 (200) or the panel 100A (200A) as described herein. The recess-defining surface 1334 further defines upper and lower surface portions 1336 and 1335, substantially corresponding to the upper and lower surface portions 336 and 335, and which co-operate to define an opening 1333 of the insert 1000, substantially similar to the opening 333 of the panel 100 (200) or the panel 100A (200A), for disposition of the mounting assembly in the recess 1313, for example, the mounting assembly-receiving space 1314. In some embodiments, for example, while the mounting assembly is received in the recess 1313 of the insert 1000, the mounting assembly is received in the recess 313 of the panel 100B (200B). In some embodiments, for example, an extension of a component of the mounting assembly, such as the intermediate member 520 or the first and second retention counterparts 622 and 626, through the opening 1333, is an extension of the component of the mounting assembly, such as the intermediate member 520 or the first and second retention counterparts 622 and 626, through the opening 333 of the panel 100B (200B).

In some embodiments, for example, the longitudinal cross-sectional shape of the insert 1000 corresponds to the longitudinal cross-sectional shape of the recess-defining surface 334 of the panel 100B (200B). In some embodiments, for example, as depicted in FIG. 101, the longitudinal cross-section of the recess-defining surface 334 of the panel 100B (200B) has a T-shape, and the longitudinal cross-section of the insert 1000 has a corresponding T-shape. In some embodiments, for example, the recess 1313 and the space 1314 have a T-shape. In this respect, the recess 1313 is a T-shaped recess 1313 and the space 1314 is a T-shaped space 1314. In some embodiments, for example, the longitudinal cross-section of the recess-defining surface 334 of the panel 100B (200B) has an L-shape, and the longitudinal cross-section of the insert 1000 has a corresponding L-shape. In some embodiments, for example, the recess 1313 and the space 1314 have an L-shape. In this respect, the recess 1313 is an L-shaped recess 1313 and the space 1314 is an L-shaped space 1314.

In some embodiments, for example, the mounting assemblies described herein are configured to co-operate with the insert 1000, which is disposed in the recess 313 of the panels described herein, such as the panel 100 (200), the panel 100A (200A), or the panel 100B (200B), in particular, are configured to co-operate with the recess-defining surface 1334 of the insert 1000, which includes the retaining surface configuration 1332 and the upper and lower surface portions 1336, 1335, to establish the received configuration, to effectuate disposition of the received configuration in the release-effective relationship and the retention-effective relationship, and to transition between the release-effective relationship and the retention-effective relationship, in a manner substantially similar to the manner as described herein with respect to the mounting assemblies described herein, such as mounting assemblies 500, 600, 600A, 600B, or 600C, and the panels described herein, such as panel 100 (200) or the panel 100A (200A).

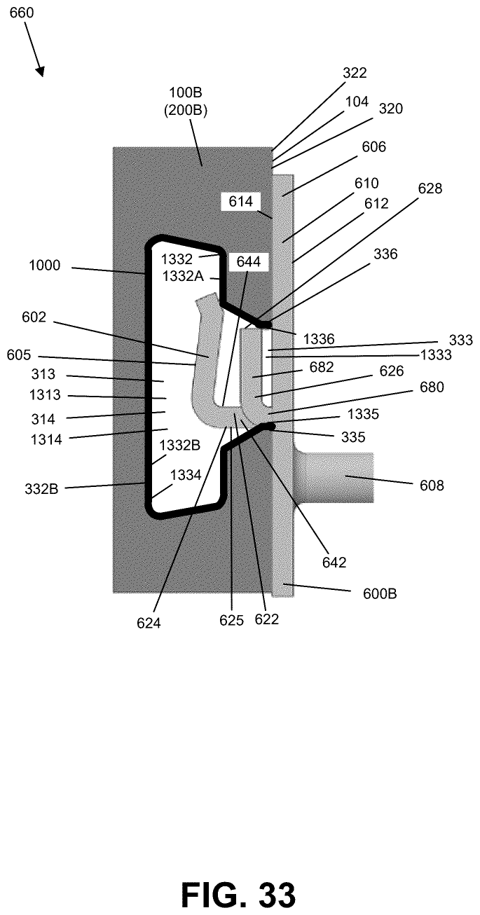

For example, FIG. 33 depicts a received configuration 660 established by the mounting assembly 600B and the panel 100B (200B) that includes an insert 1000 disposed in the recess 1313, wherein the received configuration 660 is disposed in the retention-effective relationship. As depicted, while the received configuration 660 is established and disposed in the retention-effective relationship, the first rotation-opposing surface 624 and the lower surface portion 1335 of the insert 1000 are disposed in opposing relationship (e.g. abutting relationship), and the second rotation-opposing surface 628 and the upper surface portion 1336 of the insert 1000 are disposed in opposing relationship (e.g. abutting relationship), such that rotation of the mounting assembly 600B, relative to the panel 100A (200A), and therefore, the insert 1000, in the retention direction, is opposed (e.g. prevented).

In some embodiments, for example, there is provided a kit for an assembly, and the kit includes a panel described herein, such as a panel 100 or panel panel 200B, and further includes a mounting assembly or accessory mount as described herein, such as the mounting assembly 500, the mounting assembly 600, the mounting assembly 750, or the mounting assembly 850, and further includes an insert, such as insert 1000, configured to be disposed in the recess of the panel. In some embodiments, for example, the kit includes more than one panel, and the panel is configured to co-operate with the other ones of the panels in the manner described herein. In some embodiments, for example, the kit includes end trims components, such as end trim components 2100, that are co-operatively connectible to the terminal panels in the series (via a similar connection as that for the panels).

The teaching disclosed herein makes reference to a variety of examples. The purpose served by the disclosure, however, is to provide examples of the various features and concepts related to the disclosure, not to limit the scope of any claimed invention. One skilled in the relevant art will recognize that numerous variations and modifications may be made to the examples described above without departing from the scope of the teaching disclosed herein.

1. An accessory mount for securing a slatwall accessory to a slatwall, the accessory mount comprising:
a) a base having a base width and a base back surface including an engagement portion for engaging a front face of the slatwall adjacent a channel opening in the slatwall, and the base defining a connection portion forward of the back surface for connection with an accessory load supporter;
b) a stem protruding rearward from the back surface of the base along a stem axis, the stem fixed relative to the base, and the stem having a stem width perpendicular to the stem axis and parallel to the base width; and
c) a retainer protruding orthogonally from the stem along a retainer axis, the retainer fixed relative to the stem, the retainer having a retainer width parallel to the stem width and the retainer including a retainer abutment surface directed toward the back surface of the base, the retainer abutment surface spaced apart from the back surface by a retainer gap;
wherein the retainer width and the stem width are sufficiently narrow for insertion of the retainer and stem between an opening upper edge and an opening lower edge of the channel opening when the retainer axis is oriented parallel to the channel to place the accessory mount in a partially installed position in which the retainer axis is parallel to the channel and the back surface engages the front face of the slatwall adjacent the channel opening;
wherein the accessory mount is rotatable to a fully installed position in which the retainer axis is oriented perpendicular to the channel and at least a lower portion of a flange of the slatwall extending upward form the opening lower edge is received in the retainer gap; and
wherein the base width is greater than the retainer width and the stem width, for providing non-insertability of the base into the channel opening and for providing engagement of the base back surface against the front face of the slatwall when the accessory mount is in and moved between the partially installed position and the fully installed position.

2. The accessory mount of claim 1, wherein the stem comprises a planar lower abutment surface for flush engagement with a lower bearing surface of the channel when the accessory mount is in the fully installed position, for inhibiting downward displacement of the accessory mount relative to the slatwall.

3. The accessory mount of claim 2, wherein the lower abutment surface includes a lower rotation-limiting surface for preventing further rotation of the accessory mount in a direction away from the partially installed position when the accessory mount is in the fully installed position, the lower rotation limiting surface disposed at a greater distance from the stem axis than the upper abutment surface.

4. The accessory mount of claim 2, further comprising a lower rotation-enabling surface adjacent the lower abutment surface, the lower rotation-enabling surface spaced apart from the stem axis by a distance less than or equal to that of the lower abutment surface.

5. The accessory mount of claim 2, wherein at least one of the stem and the retainer comprises a planar upper abutment surface for flush engagement with an upper bearing surface of the channel when the accessory mount is in the fully installed position, for inhibiting upward displacement of the accessory mount relative to the slatwall.

6. The accessory mount of claim 5, wherein the upper abutment surface is disposed on the stem, opposite the lower abutment surface.

7. The accessory mount of claim 5, wherein the upper abutment surface is disposed on an end face of the retainer spaced apart from the stem.

8. The accessory mount of claim 5, wherein the upper abutment surface includes an upper rotation-limiting surface for preventing further rotation of the accessory mount in a direction away from the partially installed position when the accessory mount is in the fully installed position, the upper rotation limiting surface disposed at a greater distance from the stem axis than the upper abutment surface.

9. The accessory mount of claim 5, further comprising an upper rotation-enabling surface adjacent the upper abutment surface, the upper rotation-enabling surface spaced apart from the stem axis by a distance less than or equal to that of the upper abutment surface.

10. The accessory mount of claim 1, wherein the base, the stem, and the retainer are of integral, unitary construction.

11. The accessory mount of claim 10, formed of a plastic material by injection molding.

12. The accessory mount of claim 10, formed of metal by a casting process.

13. The accessory mount of claim 10, formed by an additive manufacturing process.

14. The accessory mount of claim 10, wherein the accessory load supporter is of integral, unitary construction with the base and connected with the connection portion thereof.

15. The accessory mount of claim 1, wherein the connection portion of the base comprises a first coupling interface engageable with a second coupling interface of the accessory load supporter for releasably connecting the accessory load supporter and the base.

16. In combination, a wall panel and an accessory mount for securing a load carrying accessory to the wall panel;
the wall panel comprising:
a) a panel axis extending lengthwise of the wall panel, wherein when the wall panel is mounted to a wall for use, the panel axis is oriented horizontally and parallel to the wall;
b) a panel front face oriented vertically when the wall panel is oriented for use; and
c) a channel extending along a channel axis parallel to the panel axis, the channel including a channel opening in the panel front face, the channel opening defined at least partially by an opening upper edge and an opening lower edge spaced vertically above the opening lower edge when the panel is oriented for use, and the channel including a flange extending upward from the opening upper edge; and
the accessory mount comprising:
d) a base having a base width and a base back surface including an engagement portion for engaging the panel front face adjacent the channel opening, and the base defining a connection portion forward of the back surface for connection with an accessory load supporter;
e) a stem protruding rearward from the back surface of the base along a stem axis, the stem fixed relative to the base, and the stem having a stem width perpendicular to the stem axis and parallel to the base width; and
f) a retainer protruding orthogonally from the stem along a retainer axis, the retainer fixed relative to the stem, the retainer having a retainer width parallel to the stem width and the retainer including a retainer abutment surface directed toward the back surface of the base, the retainer abutment surface spaced apart from the back surface by a retainer gap;
wherein the retainer width and the stem width are sufficiently narrow for insertion of the retainer and stem between the opening upper edge and the opening lower edge of the channel opening when the retainer axis is oriented parallel to the channel axis to place the accessory mount in a partially installed position in which the retainer axis is parallel to the channel and the back surface engages the panel front face adjacent the channel opening;
wherein the accessory mount is rotatable to a fully installed position in which the retainer axis is oriented perpendicular to the channel and at least a lower portion of the flange of the slatwall extending upward form the opening lower edge is received in the retainer gap; and
wherein the base width is greater than the retainer width and the stem width, for providing non-insertability of the base into the channel opening and for providing engagement of the base back surface against the panel front face when the accessory mount is in and moved between the partially installed position and the fully installed position.

17. The combination of claim 16, wherein the channel is located proximate an upper edge portion of the wall panel when oriented in use, and the panel front face includes a first front face planar portion extending vertically downward from the opening lower edge, and wherein the base back surface bears against the first front face planar portion.

18. The combination of claim 17, further including an additional wall panel having a lower edge portion coupled to the upper edge portion, the lower edge portion including a downwardly extending leg overlying the upper edge portion, the leg having a second front face planar portion that extends upwardly from the opening upper edge and is coplanar with the first front face planar portion.

19. The combination of claim 17, wherein the channel includes a lower bearing surface comprising the opening lower edge of the channel and a surface extending inward from the opening lower edge, and wherein the stem comprises a planar lower abutment surface for flush engagement with the lower bearing surface of the channel when the accessory mount is in the fully installed position.

20. The combination of claim 19, wherein the planar lower abutment surface of the stem includes a lower rotation-limiting surface for preventing further rotation of the accessory mount in a direction away from the partially installed position when the accessory mount is in the fully installed position, the lower rotation limiting surface disposed at a greater distance from the stem axis than the upper abutment surface.
